(19) United States
(12) Patent Application Publication
(10) Pub. No.: US 2025/0216139 A1
(43) Pub. Date: Jul. 3, 2025

(54) REFRIGERATOR

(71) Applicant: SAMSUNG ELECTRONICS CO., LTD., Suwon-si, Gyeonggi-do (KR)

(72) Inventors: Jin JEONG, Suwon-si (KR); Gahyeong KIM, Suwon-si (KR); Kwanyeol LEE, Suwon-si (KR); Dongho LEE, Suwon-si (KR)

(73) Assignee: SAMSUNG ELECTRONICS CO., LTD., Suwon-si, Gyeonggi-do (KR)

(21) Appl. No.: 18/968,068

(22) Filed: Dec. 4, 2024

Related U.S. Application Data
(63) Continuation of application No. PCT/KR2024/017183, filed on Nov. 4, 2024.

(30) Foreign Application Priority Data
Dec. 29, 2023 (KR) 10-2023-0197858

(51) Int. Cl. F25C 5/08; F25C 1/24

(52) U.S. Cl. CPC F25C 5/08; F25C 1/24; F25C 2400/10

(57) ABSTRACT

A refrigerator may include: an ice tray configured to form ice; and a tray frame including a frame body to support the ice tray and a terminal connected to the frame body. The frame body may include a heat-generating material. The tray frame may be configured so that, with the ice tray supported by the frame body, a voltage is appliable to the terminal to generate a current flow through the heat-generating material so that the heat-generating material generates heat that is transferred by the frame body to the ice tray to heat the ice tray.

### CROSS-REFERENCE TO RELATED APPLICATIONS

This is a continuation application, under 35 U.S.C. §111(a), of International Application No. PCT/KR2024/017183, filed Nov. 4, 2024, which claims priority under 35 U.S.C. §119 to Korean Patent Application No. 10-2023-0197858, filed Dec. 29, 2023, in the Korean Intellectual Property Office, the disclosures of which are incorporated herein in their entireties by reference.

### DESCRIPTION

### Technical Field

The disclosure relates to a refrigerator, and more specifically, to a refrigerator including an ice maker.

### Background Art

A refrigerator is an appliance that stores food in a fresh state by including a body having a storage compartment and a cold air supply system configured to supply cold air to the storage compartment. The storage compartment includes a refrigerating compartment maintained at a temperature of about 0 to 5° C. to refrigerate and store food and a freezing compartment maintained at a temperature of about −30 to 0° C. to freeze and store food. Generally, the storage compartment is provided to have an open front surface to allow food to be put in and taken out, and the open front surface of the storage compartment is opened and closed by a door.

The refrigerator repeats a cooling cycle in which a refrigerant is compressed, condensed, expanded, and evaporated using a compressor, a condenser, an expander, and an evaporator. Here, both the freezing compartment and the refrigerating compartment may be cooled by a single evaporator provided at the freezing compartment side, or an evaporator may be provided in each of the freezing compartment and the refrigerating compartment for the freezing compartment and the refrigerating compartment to be independently cooled.

An ice maker configured to form ice may be provided in the refrigerator. The ice maker may automatically form ice by including an ice tray in which ice is formed, an ejector configured to eject the ice from the ice tray, an ice bucket configured to store the ice ejected from the ice tray, and a controller configured to control the ice making process.

### DISCLOSURE

### Technical Problem

One aspect of the disclosure provides a refrigerator having an improved structure that may efficiently discharge ice from an ice tray.

One aspect of the disclosure provides a refrigerator having an improved structure that may efficiently remove ice residue from an ice tray after ice is discharged from the ice tray.

One aspect of the disclosure provides a refrigerator having an improved structure that may prevent freezing of water in a water supply guide.

One aspect of the disclosure provides a refrigerator having an improved structure that may allow an ice tray to be heated or heat to be generated in a water supply guide without having a separate heater.

One aspect of the disclosure provides a refrigerator having an improved structure that may enhance the heating efficiency of an ice tray or the heat generation efficiency in a water supply guide.

One aspect of the disclosure provides a refrigerator having an improved structure that may efficiently transfer generated heat to ice.

The technical objectives of the disclosure are not limited to the above, and other objectives may become apparent to those of ordinary skill in the art based on the following descriptions.

### Technical Solution

A refrigerator according to an embodiment of the disclosure may include: an ice tray configured to form ice; and a tray frame including a frame body to support the ice tray and a terminal connected to the frame body. The frame body may include a heat-generating material. The tray frame may be configured so that, with the ice tray supported by the frame body, a voltage is appliable to the terminal to generate a current flow through the heat-generating material so that the heat-generating material generates heat that is transferred by the frame body to the ice tray to heat the ice tray.

With the ice tray supported by the frame body, the frame body may contact an edge of the ice tray.

At least a portion of the terminal may be inserted into the frame body.

The terminal may include: an insertion portion inserted into the frame body, and a connecting portion extending from the insertion portion to outside of the frame body.

The refrigerator may further include: a power supply configured to apply the voltage to the terminal; and a terminal connector electrically connected to the power supply by a wire. The terminal connector may be connected to the connecting portion to electrically connect the power supply with the terminal.

The terminal may include a pair of terminals coupled to the frame body, and a first terminal of the pair of terminals may be coupled to a first side of the frame body in a longitudinal direction of the frame body, and a second terminal of the pair of terminals may be coupled to a second side of the frame body in the longitudinal direction.

The ice tray may include a plurality of ice-making cells in which water may be storable and ice may be formable. The plurality of ice-making cells may be arranged along the longitudinal direction of the frame body. The first terminal of the pair of terminals may be arranged adjacent to an ice-making cell of the plurality of ice-making cells that is located at a first end of the frame body in the longitudinal direction. The second terminal of the pair of terminals may be arranged adjacent to an ice-making cell of the plurality of ice-making cells that may be located at a second end of the frame body in the longitudinal direction that may be opposite to the first end.

The ice tray may be a first ice tray, and the refrigerator may further include a second ice tray configured to be couplable to, and separatable from, the first ice tray so that, with the second ice tray coupled to the first ice tray, the first ice tray and the second ice tray together form an ice-making cell in which water may be storable and ice may be formable.

The tray frame may be configured so that, with the voltage applied to the terminal so as to generate the current flow through the heat-generating material so that the heat-generating material generates heat, the tray frame may transfer at least a portion of the generated heat to an area in which the first ice tray contacts the second ice tray when the second ice tray is coupled to the first ice tray.

The first ice tray may include a contact portion along an edge of the ice-making cell, the contact portion configured to, with the second ice tray coupled to the first ice tray, contact the second ice tray. The frame body may cover an outer periphery of the contact portion.

The first ice tray may be fixed to the frame body. The second ice tray may be configured to be movable between a coupled position in which the second ice tray is coupled to the first ice tray and a separated position in which the second ice tray is separated from the first ice tray.

The heat-generating material may include a carbon nanotube (CNT) material.

The heat-generating material is a first heat-generating, and the refrigerator may further include: a water supply pipe configured to supply water; and a water supply guide configured to guide the water supplied by the water supply pipe to the ice tray, the water supply guide including a second heat-generating material that generates heat upon current flowing through the second heat-generating material.

The refrigerator may further include a water supply guide terminal coupled to the water supply guide and configured so that a voltage may be appliable to the water supply guide terminal to generate the current flow through the another material.

The frame body and the water supply guide may be integral.

A refrigerator according to an embodiment of the disclosure may include: an ice tray configured to form ice; a water supply pipe configured to supply water; and a water supply guide including a guide body configured to guide the water supplied by the water supply pipe to the ice tray and a terminal connected to the guide bocy. The guide body may include a heat-generating material. The water supply guide may be configured so that, a voltage is appliable to the terminal to generate a current flow through the heat-generating material so that the heat-generating material generates heat.

A refrigerator according to an embodiment of the disclosure may include: an ice tray configured to form ice; a tray frame contacting the ice tray and configured to generate heat upon current flowing therethrough; a power supply configured to apply a voltage to a terminal electrically connected to the tray frame; and a controller electrically connected to the power supply. The controller may be configured to control the power supply to apply the voltage to the terminal based on a condition for heating at least a portion of the ice tray.

### DESCRIPTION OF DRAWINGS

FIG. 1 is a perspective view illustrating a refrigerator according to an embodiment of the disclosure.

FIG. 2 is a view illustrating an ice maker of a refrigerator according to an embodiment of the disclosure.

FIG. 3 is an exploded view illustrating an ice maker of a refrigerator according to an embodiment of the disclosure.

FIG. 4 is a view of a state in which components of an ice-making unit included in an ice maker of a refrigerator according to an embodiment of the disclosure are dissembled.

FIG. 5 is a view illustrating some components of an ice making unit of a refrigerator according to an embodiment of the disclosure.

FIG. 6 is a view illustrating an ice making unit of a refrigerator according to an embodiment of the disclosure.

FIG. 7 is a view illustrating some components of an ice making unit of a refrigerator according to an embodiment of the disclosure.

FIG. 8 is a view illustrating some components of an ice making unit of a refrigerator according to an embodiment of the disclosure.

FIG. 9 is an enlarged view illustrating a tray frame and terminals included in an ice maker of a refrigerator according to an embodiment of the disclosure.

FIG. 10 is an enlarged view illustrating a water supply guide and terminals included in an ice maker of a refrigerator according to an embodiment of the disclosure.

FIG. 11 is a block diagram illustrating some components of a refrigerator according to an embodiment of the disclosure.

FIG. 12 is a flowchart showing a method of controlling a refrigerator according to an embodiment of the disclosure.

FIG. 13 is a view illustrating some components of an ice making unit of a refrigerator according to an embodiment of the disclosure.

FIG. 14 is a view illustrating some components of an ice making unit of a refrigerator according to an embodiment of the disclosure.

FIG. 15 is a view illustrating some components of an ice making unit of a refrigerator according to an embodiment of the disclosure.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, “primary”, or “secondary” may be used simply to distinguish a component from other components, without limiting the component in other aspects e.g., importance or order.

Further, as used in the disclosure, the terms “front”, “rear”, “top”, “bottom”, “side”, “left”, “right”, “upper”, “lower”, and the like are defined with reference to the drawings, and are not intended to limit the shape and position of each component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it may be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it may be directly on the other component or intervening components may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage compartment also referred to as a storage room. The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate inside of the storage compartment from outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. The vacuum insulation may further include an adsorbent for adsorbing a gas and water to stably maintain a vacuum state. However, the insulation is not limited to the above-mentioned foaming insulation or vacuum insulation, and may include various materials capable of being used for insulation.

The “storage compartment” may include a space defined by the inner case. The storage compartment may further include the inner case defining the space. Medicines or cosmetics, as well as food items, may be stored in the storage compartment, and one side of the storage compartment may open to enable a user to put items in or take items out.

The refrigerator may include one or more storage compartments. In a case in which two or more storage compartments are formed in the refrigerator, the respective storage compartments may have different purposes of use, and may be maintained at different temperature. To this end, the respective storage compartments may be partitioned by a partition wall including an insulation.

The storage compartment may be maintained within an appropriate temperature range according to a purpose of use, and include a “refrigerating compartment”, a “freezing compartment”, and a “temperature conversion compartment” according to purposes of use and/or temperature ranges. The refrigerating compartment may be maintained at appropriate temperature to keep food refrigerating, and the freezing compartment may be maintained at appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of-20 degrees Celsius to-1 degrees Celsius. The temperature conversion compartment may be used as any one of a refrigerating compartment or a freezing compartment according to or regardless of a user's selection.

The storage compartment may also be called various other terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below need to be understood to represent storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted on the front of the main body.

The “door” may seal the storage compartment in a closed state. The door may include an insulation, like the main body, to insulate the storage compartment in the closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forms the front surface of the door. The door body may include an outer door plate that forms the front surface of the door body, an inner door plate that forms the rear surface of the door body and faces the storage compartment, an upper cap, a lower cap, and a door insulator provided therein.

The refrigerator may be classified as French Door Type, Side-by-side Type, Bottom Mounted Freezer BMF, Top Mounted Freezer TMF, or One Door Refrigerator depending on the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cool air to cool the storage compartment.

According to an embodiment of the disclosure, the cold air supply device may generate cold air through a cooling cycle including compression, condensation, expansion, and evaporation processes of refrigerants. To this end, the cold air supply device may include a cooling cycle device having a compressor, a condenser, an expander, and an evaporator to drive the cooling cycle. According to an embodiment of the disclosure, the cold air supply device may include a semiconductor such as a thermoelectric element. The thermoelectric element may cool the storage compartment by heating and cooling actions through the Peltier effect.

The refrigerator according to an embodiment of the disclosure may include a machine compartment where at least some components belonging to the cold air supply device are installed.

The “machine compartment” may be partitioned and insulated from the storage compartment to prevent heat generated from the components installed in the machine compartment from being transferred to the storage compartment. To dissipate heat from the components installed inside the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-maker that forms ice. The ice-maker may include an ice-making tray that stores water, an ice moving device that separates ice from the ice-making tray, and an ice-bucket that stores ice generated in the ice-making tray.

The refrigerator according to an embodiment of the disclosure may include a controller for controlling the refrigerator.

The “controller” may include a memory for storing and/or memorizing data and/or programs for controlling the refrigerator, and a processor for outputting control signals for controlling the cold air supply device, etc. according to the programs and/or data memorized in the memory.

The memory may store or record various information, data, commands, programs, and the like necessary for operations of the refrigerator. The memory may store temporary data generated while generating control signals for controlling components included in the refrigerator. The memory may include at least one of volatile memory or non-volatile memory, or a combination thereof.

The processor may control the overall operation of the refrigerator. The processor may control the components of the refrigerator by executing programs stored in memory. The processor may include a separate neural processing unit NPU that performs an operation of an artificial intelligence AI model. In addition, the processor may include a central processing unit CPU, a graphics processor GPU, and the like. The processor may generate a control signal to control the operation of the cold air supply device. For example, the processor may receive temperature information of the storage compartment from a temperature sensor, and generate a cooling control signal for controlling an operation of the cold air supply device based on the temperature information of the storage compartment.

Furthermore, the processor may process a user input of a user interface and control an operation of the user interface according to the programs and/or data memorized/stored in the memory. The user interface may be provided using an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all the components included in the refrigerator, and may include a plurality of processors and a plurality of memories for individually controlling the components of the refrigerator. For example, the refrigerator may include a processor and a memory for controlling the operation of the cold air supply device according to an output of the temperature sensor. In addition, the refrigerator may be separately equipped with a processor and a memory for controlling the operation of the user interface according to the user input.

A communication module may communicate with external devices, such as servers, mobile devices, and other home appliances via a nearby access point AP. The AP may connect a local area network LAN to which a refrigerator or a user device is connected to a wide area network WAN to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, various embodiments according to the disclosure will be described in detail with reference to the accompanying drawings.

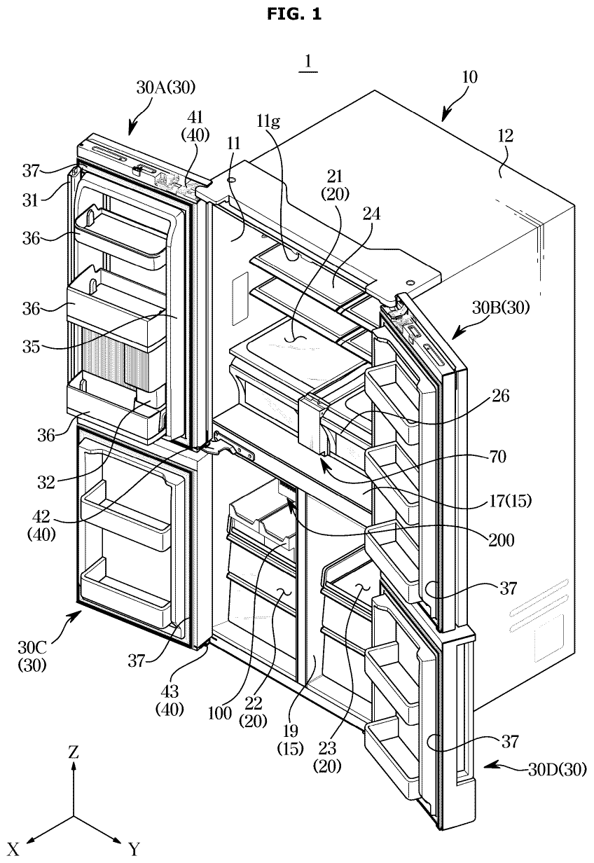

In the following description of embodiments according to the concept of the disclosure with reference to FIGS. 1 to 15, the terms “front”, “rear”, “top”, “bottom”, “left”, “right”, and the like are defined with reference to the drawings, and are not intended to limit the shape and position of each component. For example, “front” and “rear” may refer to an x axis that includes opposite directions (e.g., a +X direction and a −X direction) with reference to the drawing. For example, “top” and “bottom” may refer to a z axis that includes opposite directions (e.g., a +Z direction and a −Z direction) with reference to the drawing. For example, “left” and “right” may refer to an x axis that includes opposite directions (e.g., a +Z direction and a −Z direction) with reference to the drawing.

FIG. 1 is a perspective view illustrating a refrigerator according to an embodiment of the disclosure.

Referring to FIG. 1, a refrigerator 1 according to one embodiment of the disclosure may include a main body 10, a storage compartment 20 disposed inside the main body 10, a door 30 configured to open and close the storage compartment 20, and a cooling system for supplying cold air to the storage compartment 20.

The main body 10 may include an inner case 11 provided to form the storage compartment 20 and an outer case 12 provided to form an exterior of the refrigerator 1.

The outer case 12 may be formed to have the shape of a box in which a front surface is open. The outer case 12 may form an upper surface, a lower surface, left and right surfaces, a rear surface, etc. of the refrigerator 1.

The inner case 11 may have a front surface that is open. The storage compartment 20 may be disposed in the inner case 11 and the inner case 11 may be disposed inside the outer case 12. An inner wall of the inner case 11 may form an inner wall of the storage compartment 20.

The storage compartment 20 may be formed inside the main body 10. For example, the storage compartment 20 may include a refrigerating compartment in which food is kept refrigerated by maintaining the temperature at approximately 0 to 5 degrees Celsius. For example, the storage compartment 20 may include a freezing compartment in which food is kept frozen by maintaining the temperature at approximately −30 to 0 degrees Celsius.

For example, the storage compartment 20 may be divided into a plurality of regions by a partition 15. Particularly, by a first partition 17 extending in the parallel direction, the storage compartment 20 may be divided into a first storage compartment 21 disposed in an upper portion thereof and lower storage compartments 22 and 23 disposed in a lower portion thereof. In addition, the storage compartments 22 and 23 disposed in the lower portion of the storage compartment 20 may be divided into a second storage compartment 22 on the left and a third storage compartment 23 on the right by a second partition 19 extending in the vertical direction. In this case, the first storage compartment 21 may be used as the refrigerating compartment. Both the second storage compartment 22 and the third storage compartment 23 may be used as the freezing compartment. Alternatively, one of the second storage compartment 22 and the third storage compartment 23 may be used as the freezing compartment and the other of the second storage compartment 22 and the third storage compartment 23 may be used as the refrigerating compartment.

The division method of the storage compartment 20 and the purposes of each of the divided storage compartments 21, 22, and 23 are only examples and are not limited thereto. However, in this embodiment, it is described assuming that the second storage compartment 22 is a freezing compartment.

A shelf 24 on which food is placed and a storage container 26 in which food is stored may be provided in the storage compartment 20.

The refrigerator 1 may include a cooling system configured to generate cold air using a cooling cycle and supply the generated cold air to the storage compartment 20. The cooling system may generate cold air using a refrigeration circulation cycle that compresses, condenses, expands, and evaporates a refrigerant. For example, the cooling system may include a compressor, a condenser, an expansion valve, an evaporator, a blower fan, etc.

The main body 10 may include a cold air supply duct provided to form a cold air flow path through which cold air generated by the cooling system flows into the storage compartment 20. The cold air supply duct may be formed in a rear portion of the inner case 11, and may be disposed at the rear of the storage compartment 20 and communicate with the storage compartment 20.

The door 30 may be configured to open and close the storage compartment 20. The door 30 may be configured to open and close an opening formed on one side of the main body 10. The door 30 may be configured to be rotatable with respect to the main body 10.

An outer surface of the door 30 may form a portion of the exterior of the refrigerator 1. When the door 30 is in a closed position, the outer surface of the door 30 may form at least a portion of a front exterior of the refrigerator 1. When the door 30 is in the closed position, an inner surface of the door 30 may face the inside of the storage compartment 20. The inner surface of the door 30 refers to one surface of the door 30 facing the storage compartment 20 when the door 30 closes the storage compartment 20. In addition, the outer surface of the door 30 refers to the other surface opposite to the inner surface of the door 30 facing the storage compartment 20 when the door 30 closes the storage compartment 20, and refers to the front surface of the door 30 when the refrigerator 1 is viewed from the front.

A door gasket 37 provided to seal a gap between the door 30 and the main body 10 to prevent cold air from leaking into the storage compartment 20 may be disposed on the inner surface of the door 30. The door gasket 37 may be arranged along an inner circumference of the door 30. The door gasket 37 may be formed of an elastic material such as rubber.

The refrigerator 1 may include a plurality of doors 30A, 30B, 30C, and 30D configured to open and close each partitioned storage compartment 21, 22, and 23.

Particularly, the first storage compartment 21 may be opened and closed by a pair of upper doors 30A and 30B. The refrigerator 1 may include a first door 30A configured to open and close a portion of the first storage compartment 21 and a second door 30B configured to open and close another portion of the first storage compartment 21. The first door 30A and the second door 30B may be arranged to open and close one first storage compartment 21. The first door 30A and the second door 30B may each be rotatable independently of each other with respect to the main body 10.

The first door 30A and the second door 30B may be arranged side by side with each other. Particularly, the first door 30A and the second door 30B may be arranged side by side in the parallel direction Y direction. For example, the first door 30A may be configured to open and close a left portion of the first storage compartment 21, and the second door 30B may be configured to open and close a right portion of the first storage compartment 21.

The refrigerator 1 may include a rotation bar 500. The rotation bar 500 may be configured to be rotatable with respect to one of the pair of upper doors 30A and 30B e.g., first door 30A, and provided to cover a gap between the pair of upper doors 30A and 30B when the pair of upper doors 30A and 30B closes the first storage compartment 21.

The rotation bar 31 may be provided to cover a gap between the first door 30A and the second door 30B when the first door 30A and the second door 30B close the first storage compartment 21. The rotation bar 31 may be rotatably coupled to the first door 30A. The rotation bar 31 may be formed in the shape of a bar that is elongated along the height direction Z of the first door 30A.

As illustrated in FIG. 1, the refrigerator 1 may include a rotation guide 11g provided to guide the rotation of the rotation bar 31. The rotation guide 11g may be provided to guide the rotation of the rotation bar 31 when the first door 30A is opened and closed. The rotation guide 11g may include a groove structure into which a portion of the rotation bar 31 is inserted for movement. The rotation guide 11g may be mounted on the main body 10. Specifically, the rotation guide 11g may be mounted on an upper portion of the inner case 11.

The second storage compartment 22 may be opened and closed by a lower left door 30C. The refrigerator 1 may include a third door 30C configured to open and close the second storage compartment 22. The third door 30C may be configured to be rotatable with respect to the main body 10. For example, the first door 30A and the third door 30C may be arranged side by side in the vertical direction Z.

The third storage compartment 23 may be opened and closed by a lower right door 30D. The refrigerator 1 may include a fourth door 30D configured to open and close the third storage compartment 23. The fourth door 30D may be configured to be rotatable with respect to the main body 10. For example, the second door 30B and the fourth door 30D may be arranged side by side in the vertical direction Z. Additionally, the third door 30C and the fourth door 30D may be arranged side by side in the parallel direction Y.

For example, a handle may be provided on each of the plurality of doors 30A, 30B, 30C, and 30D, and a user may hold the handle provided on each of the plurality of doors 30A, 30B, 30C, and 30D to open and close each door 30A, 30B, 30C, and 30D. In other words, a user may open or close each storage compartment 21, 22, and 23 by holding the handle provided on each of the plurality of doors 30A, 30B, 30C, and 30D.

A door basket 36 provided to store food may be disposed on a rear surface of the first door 30A. A dyke 35 protruding to allow the door basket 36 to be mounted may be provided on the rear surface of the door 30.

The door 30 may be provided with an automatic water supply device that is provided to automatically supply water to a water container. For example, the door 30 may be provided with a water container mounting portion 72 on which a water container is mounted, a water container detection sensor for detecting whether a water container is mounted on the water container mounting portion 72, and a water level sensor for detecting the water level inside the water container when a water container is mounted on the water container mounting portion 72. The automatic water supply device may, based on determining that a water container is mounted on the water container mounting portion 72 and the water level inside the water container is not at a full level, supply a predetermined amount of water to the water container.

Although not shown in the drawings, the door 30 may also be provided with a dispenser that provides purified water.

The refrigerator 1 may include a hinge 40 provided to connect the main body 10 and the door 30. The hinge 40 may be provided to allow the door 30 to be rotatable with respect to the main body 10.

The hinge 40 may be fixed to the main body 10. Particularly, the hinge 40 may be coupled to the outer case 12.

The hinge 40 may rotatably support the door 30. The door 30 may be rotatably coupled to the main body 10 by the hinge 40. A rotation axis of the door 30 may pass through the hinge 40.

Particularly, the refrigerator 1 may include a plurality of hinges 41, 42, and 43 provided to support each of the plurality of doors 30A, 30B, 30C, and 30D.

For example, the refrigerator 1 may include an upper door hinge 41. The upper door hinge 41 may be coupled to an upper portion of the main body 10. For example, the upper door hinge 41 may be provided as a pair so as to rotatably support the first door 30A and the second door 30B, respectively. The pair of upper door hinges 41 may be disposed on the upper left and upper right sides of the main body 10, respectively. Each of the pair of upper door hinges 41 may be coupled to an upper portion of the first door 30A and an upper portion of the second door 30B.

For example, the refrigerator 1 may include a lower door hinge 43. The lower door hinge 43 may be coupled to a lower portion of the main body 10. For example, the lower door hinge 43 may be provided as a pair so as to rotatably support the third door 30C and the fourth door 30D, respectively. The pair of lower door hinges 43 may be disposed on the lower left and lower right sides of the main body 10, respectively. Each of the pair of lower door hinges 43 may be coupled to a lower portion of the third door 30C and a lower portion of the fourth door 30D.

For example, the refrigerator 1 may include an intermediate hinge 42. The intermediate hinge 42 may be coupled to a middle portion of the main body 10. The intermediate hinge 42 may be disposed between the upper door hinge 41 and the lower door hinge 43. For example, the intermediate hinge 42 may be provided as a pair so as to rotatably support the first door 30A and the second door 20B, respectively. Additionally, the intermediate hinges 42 may be provided as a pair so as to rotatably support the third door 30C and the fourth door 30D, respectively. The pair of intermediate hinges 42 may be provided on the left and right sides of the middle portion of the main body 10, respectively. Each of the pair of intermediate hinges 42 may be coupled to the lower portion of the first door 30A and the lower portion of the second door 20B. Additionally, each of the pair of intermediate hinges 42 may be coupled to the upper portion of the third door 30C and the upper portion of the fourth door 30D.

The upper door hinge 41 and the intermediate hinge 42 may be arranged side by side along the direction in which the rotation axes of the first door 30A and the second door 30B extend. As shown in FIG. 1, the upper door hinge 41 and the intermediate hinge 42 may be arranged side by side in the vertical direction Z.

The lower door hinge 43 and the intermediate hinge 42 may be arranged side by side along the direction in which the rotation axes of the third door 30C and the fourth door 30D extend. As shown in FIG. 1, the lower door hinge 43 and the intermediate hinge 42 may be arranged side by side in the vertical direction Z.

The refrigerator 1 may include a water supply device 70. The water supply device 70 may be provided to purify and store water supplied from an external water source (not shown). For example, the water supply device 70 may include a filter provided to filter raw water, a water tank for storing purified water, and the like.

The water supply device 70 may be provided to supply the purified water or the purified and then stored water to another device. For example, the water supply device 70 may be provided to supply water to an ice maker 200 described below.

The water supply device 70 may be arranged in the storage compartment 20. Specifically, the water supply device 70 may be arranged in at least one storage compartment 21, 22, and 23, and preferably, may be arranged in a refrigerating compartment (the first storage compartment 21)

The refrigerator 1 may include an ice maker 200 configured to form ice. The ice maker 200 may be arranged in the storage compartment 20. Specifically, the ice maker 200 may be arranged in the second storage compartment 22, which is a freezing compartment. The ice maker 200 may form ice using cold air from the second storage compartment 22. The ice maker 200 may be configured to discharge the formed ice.

The ice maker 200 may be mounted on the inner case 11. Alternatively, the ice maker 200 may be mounted on the partition 15.

For example, as illustrated in FIG. 1, the ice maker 200 may be supported by the first partition 17 and the second partition 19. Alternatively, unlike as shown in FIG. 1, the ice maker 200 may be mounted on a portion of the inner case 11 forming the second storage compartment 22.

The refrigerator 1 may include an ice bucket 100 provided to accommodate ice formed by the ice maker 200. Ice formed by the ice maker 200 and then discharged may be accommodated in the ice bucket 100.

The ice bucket 100 may be provided inside the second storage compartment 22. The ice bucket 100 may be disposed below the ice maker 200 inside the second storage compartment 22. The ice bucket 100 may be provided to accommodate ice discharged from the ice maker 200 and moved downward.

The configuration of the refrigerator 1 described above with reference to FIG. 1 is only an example for describing a refrigerator according to the concept of the disclosure, and the concept of the disclosure is not limited thereto. The refrigerator according to the concept of the disclosure may be provided to include various configurations for performing a function of supplying cold air to a storage compartment for storing food.

The type of refrigerator, to which the refrigerator according to the disclosure is applied, is not limited to the type of refrigerator 1 shown in the drawing, and the refrigerator according to the disclosure may include various types of refrigerators such as side-by-side type, French door type, Bottom Mounted Freezer BMF type, Top Mounted Freezer TMF type or one-door type.

In addition, the refrigerator 1 according to the disclosure is described on the assumption that the refrigerator is an indirect cooling type, but is not limited thereto. The disclosure may be applied to a direct cooling type refrigerator.

Hereinafter for convenience of description, embodiments illustrated in FIGS. 1 to 15 will be described in detail based on the refrigerator 1 shown in FIG. 1 an embodiment.

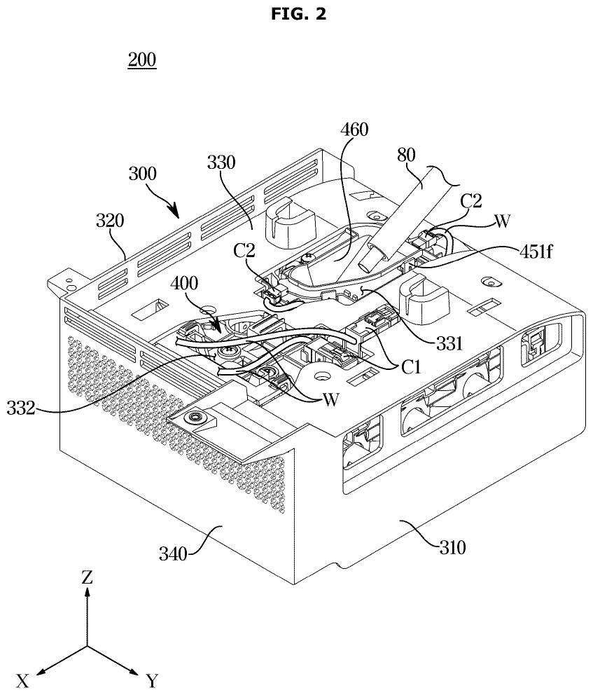

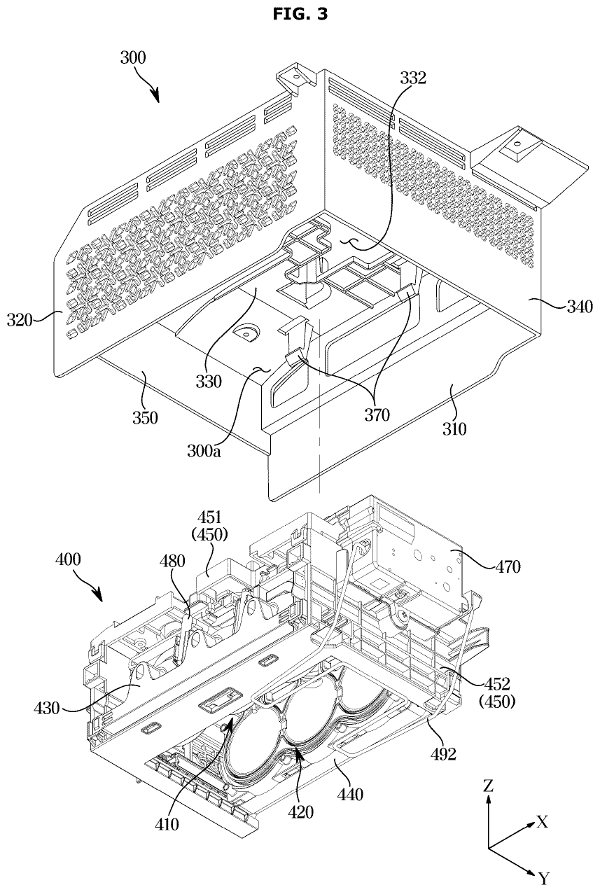

FIG. 2 is a view illustrating an ice maker of a refrigerator according to an embodiment of the disclosure. FIG. 3 is an exploded view illustrating an ice maker of a refrigerator according to an embodiment of the disclosure.

Referring to FIGS. 2 and 3, an ice maker 200 of a refrigerator 1 according to an embodiment of the disclosure may include an ice making unit 400 that forms ice and a support case 300 that supports the ice making unit 400.

The ice making unit 400 may be provided to form ice using cold air from the storage compartment 20. The ice making unit 400 may be provided to receive and store water, and due to the cold air from the storage compartment 20, the stored water may undergo a phase change into ice. The ice making unit 400 may be provided to discharge the formed ice.

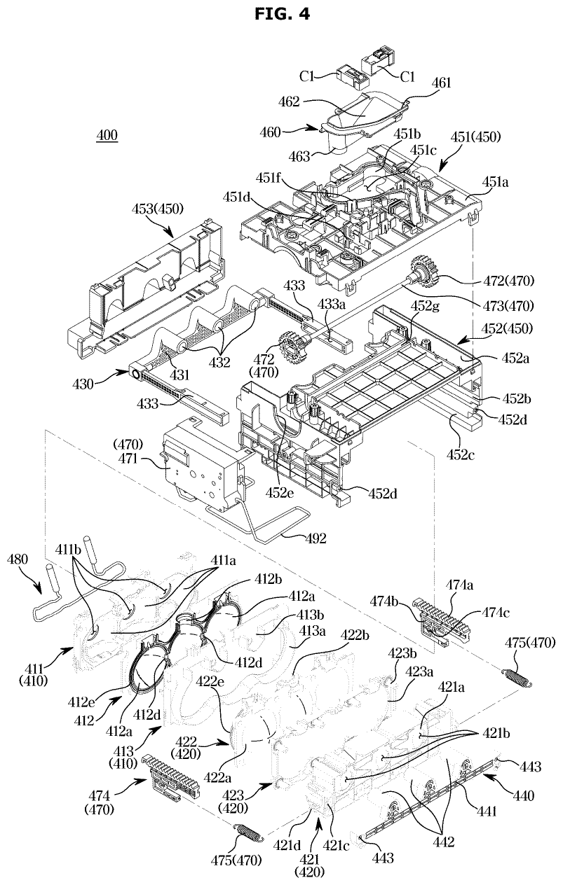

The refrigerator 1 may further include a water supply pipe 80 provided to supply water to the ice maker 200. The water supply pipe 80 may be provided to supply water from an external water supply source or the water supply device 70 to the ice maker 200. In detail, the water supply pipe 80 may be provided to supply water to ice trays (412 and 422 in FIG. 4) of the ice maker 200, which will be described below. The water introduced into the ice trays 412 and 422 may be accommodated in ice making cells (412a and 422a in FIG. 4), which will be described below, and may undergo a phase change into ice in the ice making cells 412a and 422a. As described above, the ice maker 200 may form ice using the water supplied through the water supply pipe 80.

For example, the water supply pipe 80 may have an approximate pipe shape with a hollow, and the hollow of the water supply pipe 80 may include a water supply flow path in which water flows.

The water supply pipe 80 may be arranged to penetrate the main body 10. For example, the water supply pipe 80 may be connected to the water supply device 70 of the main body 10 by penetrating the first partition 17. Alternatively, the water supply pipe 80 may be directly connected to an external water supply source by penetrating the outer case 12 and the inner case 11. More specifically, the water supply pipe 80 may penetrate the rear wall of the outer case 12 and the rear wall of the inner case 11.

For example, the ice making unit 400 may be configured to form ice having an approximately spherical shape. Alternatively, the ice making unit 400 may be configured to form ice in various shapes other than a spherical shape.

A detailed description of the configuration and operation of the ice making unit 400 will be described below.

The support case 300 of the ice maker 200 may form the exterior of the ice maker 200. The support case 300 may be provided to accommodate the ice making unit 400. The support case 300 may form an accommodation space 300a in which at least a part of the ice making unit 400 may be accommodated.

Specifically, as shown in FIGS. 2 and 3, the support case 300 may include an upper wall 330, a front wall 340, a rear wall 350, a left wall 320, and a right wall 310. The accommodation space 300a of the support case 300 may be formed between the upper wall 330, the front wall 340, the rear wall 350, the left wall 320, and the right wall 310.

The upper wall 330 of the support case 300 may form the upper surface of the support case 300. For example, the upper wall 330 of the support case 300 may face the first partition 17.

The front wall 340 of the support case 300 may form the front surface of the support case 300. The front wall 340 of the support case 300 may be oriented toward the opening of the main body 10.

The rear wall 350 of the support case 300 may form the rear surface of the support case 300. The rear wall 350 of the support case 300 may face the rear wall of the inner case 11. The rear wall 350 of the support case 300 may be arranged opposite to the front wall 340 of the support case 300.

The left wall 320 of the support case 300 may form a surface on the left side of the support case 300, and the right wall 310 of the support case 300 may be arranged opposite to the left wall 320 to form a surface on the right side of the support case 300. For example, the right wall 310 of the support case 300 may face the second partition 19.

The support case 300 may be formed such that the lower side of the accommodation space 300a is open. Ice formed in the ice making unit 400 may be discharged through the lower side of the accommodation space 300a and accommodated in the ice bucket 100.

However, the support case 300 is not limited to that shape described above, and may be provided in various shapes.

The support case 300 may support the ice making unit 400. The ice making unit 400 may be mounted on the support case 300.

The support case 300 may include an ice making unit support 370 for supporting the ice making unit 400. The ice making unit 400 may be mounted on the ice making unit support 370. For example, the ice making unit support 370 may protrude from the upper wall 330 of the support case 300 downward to support the ice making unit 400. For example, the ice making unit support 370 may include a hook structure, and the ice making unit 400 may be mounted on the ice making unit support 370 by a hook coupling.

Alternatively, the ice making unit 400 may be fixed to the support case 300 by a screw. For example, the ice making unit 400 may be fastened to the support case 300 by a screw penetrating the support case 300 and a support frame (450 in FIG. 4) of the ice making unit 400.

The disclosure is not limited thereto, and the support case 300 may be provided in various structures for supporting the ice making unit 400.

The support case 300 may be supported by the main body 10. The support case 300 while supported by the main body 10 may support the ice making unit 400. In other words, the support case 300 may be mounted on the main body 10. For example, the support case 300 may be supported by the first partition 17 or the second partition 19. For example, the support case 300 may be fastened to the first partition 17 by a screw. For example, the support case 300 may be supported by a protrusion (not shown) having a shape protruding from the inner wall, which is oriented toward the second storage compartment 22, of the second partition 19.

The support case 300 may include a first case opening 331 formed to allow water from the water supply pipe 80 to flow in. The first case opening 331 may be formed by an opening in a part of the support case 300. For example, the first case opening 331 may be formed in the upper wall 330 of the support case 300. Arranged in the first case opening 331 may be a water supply guide 460 of the ice making unit 400, which will be described below, and through the water supply guide 460, which is exposed to the outside of the support case 300 through the first case opening 331, water from the water supply pipe 80 may be introduced into the ice trays (412 and 422 in FIG. 4).

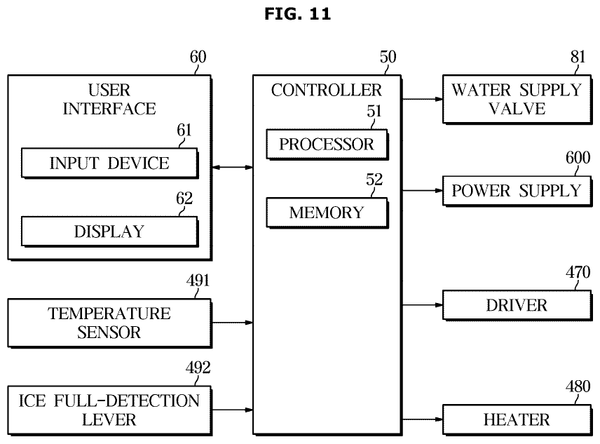

The support case 300 may include a second case opening 332 through which a wire W may pass. The second case opening 332 may be formed by an opening in a part of the support case 300. For example, the second case opening 332 may be formed in the upper wall 330 of the support case 300. The wire W may pass through the second case opening 332 to connect various components of the ice making unit 400 arranged inside the support case 300 to devices arranged outside the support case 300 (e.g., a power supply 600, a controller 50, etc., in FIG. 11).

The structure of the support case 300 is not limited to that described above, and may include various configurations capable of supporting the ice making unit 400 including the ice trays 412 and 422 described below.

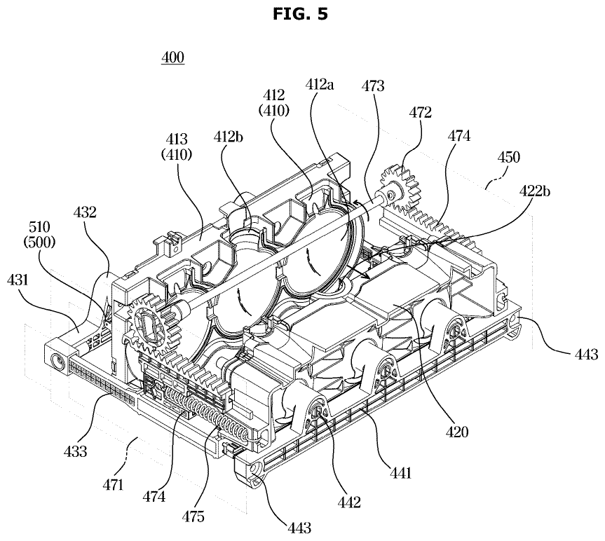

FIG. 4 is a view of a state in which components of an ice-making unit included in an ice maker of a refrigerator according to an embodiment of the disclosure are dissembled. FIG. 5 is a view illustrating some components of an ice making unit of a refrigerator according to an embodiment of the disclosure.

Referring to FIGS. 4 and 5, the ice making unit 400 may include ice trays 412 and 422 provided to form ice. The ice trays 412 and 422 may be provided to store water supplied from the water supply pipe 80 such that the water changes to ice. The ice trays 412 and 422 may include ice making cells 412a and 422a provided to store water supplied from the water supply pipe 80. The water stored in the ice making cells 412a and 422a may undergo a phase change into ice by the cold air of the storage compartment 20. The ice making cells 412a and 422a may be provided inside the ice trays 412 and 422.

For example, the ice trays 412 and 422 may be provided to form a plurality of ices simultaneously. The ice trays 412 and 422 may include a plurality of ice-making cells 412a and 422a. For example, the water supply guide 460, which will be described below, may supply collected water only to some of the plurality of ice-making cells 412a and 422a, and the plurality of ice-making cells 412a and 422a may be formed to communicate with each other such that the collected water may be supplied into all of the ice-making cells. Alternatively, the water supply guide 460 may be provided as a plurality of water supply guides 460 to correspond to the number of the plurality of ice-making cells 412a and 422a, and may supply collected water to each of the plurality of ice-making cells 412a and 422a.

In detail, the ice-making unit 400 may include a first ice tray 412 and a second ice tray 422. The first ice tray 412 and the second ice tray 422 may be provided to be coupled to or separated from each other. The first ice tray 412 and the second ice tray 422 may form a single ice tray for forming ice when coupled together. The first ice tray 412 and the second ice tray 422 may form the ice-making cells 412a and 422a together when coupled together.

The first ice tray 412 may be fixed in position, and the second ice tray 422 may be provided to be movable relative to the first ice tray 412. The second ice tray 422 may be provided to be movable between a position in which the second ice tray 422 may be coupled to the first ice tray 412 and a position in which the second ice tray 422 may be separated from the first ice tray 412. As described below, the first ice tray 412 may include the first ice-making cell 412a, and the second ice tray 422 may include the second ice-making cell 422a. When the second ice tray 422 is moved toward the first ice tray 412 and coupled to the first ice tray 412, the first ice-making cell 412a and the second ice-making cell 422a may form a single ice-making cell in which water may be stored and ice may be formed. After the ice formation is complete, ice may be discharged when the second ice tray 422 is moved in a direction of being separated from the first ice tray 412. That is, the second ice tray 422 may be provided to be movable between a position in which the second ice tray 422 is coupled to the first ice tray 412 to form an ice-making cell together with the first ice tray 412 and a position in which the second ice tray 422 is separated from the first ice tray 412.

Hereinafter, an example of a detailed structure of an ice making unit 400 including a first ice tray 412 and a second ice tray 422 is described.

The ice making unit 400 may include a support frame 450. The support frame 450 may be supported by an ice making unit support 370 of the support case 300. Each component of the ice making unit 400 may be supported by the support frame 450.

Specifically, the support frame 450 may include a first support frame 451 and a second support frame 452. The first support frame 451 may be coupled to an upper portion of the second support frame 452 to form an upper surface of the support frame 450.

The first support frame 451 may include a first support body 451a. The first support body 451a may form the outer appearance of the first support frame 451.

The first support body 451a may have a guide mounting portion 451b and a cut portion 451c mounted on the upper surface thereon. The water supply guide 460 to be described below may be mounted on the first support frame 451 by the guide mounting portion 451b. The water supply guide 460 may pass through the cut portion 451c and extend toward a region between the first ice tray 412 and the second ice tray 422.

The first support body 451a may have an intermediate connector C1 on the upper surface thereof, which will be described below. A connector mounting portion 451d on which the intermediate connector C1 is mounted may be provided on the upper surface of the first support body 451a. The intermediate connector C1 may be mounted on the connector mounting portion 451d, and thus the intermediate connector C1 and a wire W connected thereto may be stably fixed.

The second support frame 452 may include a second support body 452a. The second support body 452a may form the outer appearance of the second support frame 452.

The second support body 452amay include a rack gear mounting portion 452b. The rack gear mounting portion 452b may be formed on the inner surfaces of opposite lateral sides extending downward from the upper surface of the second support body 452a. The rack gear mounting portion 452b may be formed to accommodate a rack gear 474 to be described below. The rack gear 474 may be supported to be movable in a parallel direction with respect to the second support frame 452.

The second support body 452a may include a leg support portion 452c. The leg support portion 452c may be provided to seat a leg portion 433 of a first ejector 430 thereon. The leg portion 433 of the first ejector 430 may be supported by the leg support portion 452c. The leg portion 433 of the first ejector 430 may be supported to be movable in a parallel direction with respect to the second support frame 452.

For example, the leg support portion 452c may be formed on the inner surfaces of the opposite lateral sides extending downward from the upper surface of the second support body 452a.

The second support body 452a may include an ejector mounting portion 452d. The ejector mounting portion 452d may be provided to mount a second ejector 440 thereon. Specifically, a frame mounting portion 443 of the second ejector 440 may be fastened to the ejector mounting portion 452d of the second support frame 452 by a fastening member, such as a screw, and accordingly, the second ejector 440 may be fixed to the support frame 450.

The second support body 452a may include a pinion gear accommodating portion 452e. The pinion gear accommodating portion 452e may be provided to accommodate a pinion gear 472 of a driver 470 described below.

For example, the pinion gear accommodating portions 452e may be formed in upper portions of the opposite lateral sides extending downward from the upper surface of the second support body 452a. For example, the pinion gear 472 may be provided as a plurality of pinion gears 472 to be accommodated on the opposite lateral sides of the second support body 452a, and the rack gear 474 meshed with the pinion gear 472 may also be provided as a plurality of rack gears 474 to be accommodated on the opposite lateral sides of the second support body 452a.

The second support body 452a may include a shaft member penetration portion 452g. The shaft member penetration portion 452g may be formed in a portion of the upper surface of the second support body 452a which has been cut out. In other words, the shaft member penetration portion 452g may be formed to have a shape being recessed on the upper surface of the second support body 452a. A shaft member 473 of the driver 470 described below may be arranged to penetrate the shaft member penetration portion 452g and may be arranged inside of the support frame 450.

The support frame 450 may include a cover frame 453.

The cover frame 453 may be arranged at the front of the first support frame 451 and the second support frame 452. The cover frame 453 may be arranged to cover an open side of the second support frame 452. The cover frame 453 may form one side surface of the support frame 450. A part of the first ejector 430 may be accommodated in the cover frame 453.

The configuration of the support frame 450 described above is only an example of a support frame for supporting each component of the ice making unit 400, and the concept of the disclosure is not limited thereto. The support frame may be configured in various ways to support each component of the ice making unit 400, such as a first ice tray unit 410, a second ice tray unit 420, ejectors 430 and 440, a driver 470, and the like. In addition, while the support frame 450 shown in FIG. 4 is illustrated as including the first support frame 451, the second support frame 452, and the cover frame 453 that are distinct from each other, the support frame 450 may be formed as one part.

The ice making unit 400 may include a water supply guide 460. The water supply guide 460 may be connected to the ice trays 412 and 422. The water supply guide 460 may be provided to guide water from the water supply pipe 80 to the ice trays 412 and 422. The water supply guide 460 may be provided to guide water from the water supply pipe 80 to the inside of the ice making cells 412a and 422a formed between the first ice tray 412 and the second ice tray 422.

The water supply guide 460 may be coupled to the first ice tray 412 between the ice trays 412 and 422. The water supply guide 460 may be fixed to the first ice tray 412.

The water supply guide 460 may include a guide body 461 formed to be mounted on the first support frame 451. The guide body 461 may have a guide surface 462 on the inner side thereof, which is inclined downward. Water introduced into the water supply guide 460 may flow along the guide surface 462.

The water supply guide 460 may include a connecting portion 463 extending from the guide body 461 downward. The connecting portion 463 may be connected to inflow holes of the ice trays 412 and 422 that allow water to flow into the ice trays 412 and 422. Specifically, the connecting portion 463 may be coupled to a first inflow hole 412b formed in the first ice tray 412. The connecting portion 463 may be inserted between the first ice tray 412 and the second ice tray 422. Water flowing along the guide surface 462 may flow through the connecting portion 463 to the inside of the ice trays 412 and 422.

With such a configuration, water from the water supply pipe 80 may flow along the guide surface 462 of the water supply guide 460 to the connecting portion 463, and may be introduced into the ice trays 412 and 422.

The ice making unit 400 may include a heater 480. The heater 480 may be provided to heat the ice trays 412 and 422. For example, the heater 480 may be supported by a first tray case 411 of the first ice tray unit 410 described below and may be provided to heat the first ice tray 412 described below. The heater 480 may be provided to locally heat a portion of the first ice tray 412 for a predetermined period of time while ice is being formed in the ice trays 412 and 422 to improve the transparency of the ice.

The ice making unit 400 may include an ice-full-detection lever 492. The ice full-detection lever 492 may detect whether a predetermined amount or more of ice is stored in the ice bucket 100. When the ice full-detection lever 492 detects that a predetermined amount or more of ice is stored in the ice bucket 100 i.e., the ice bucket 100 is full of ice, the ice maker 200 may not perform an ice making operation.

The ice making unit 400 may include a first ice tray unit 410 including a first ice tray 412. The ice making unit 400 may include a second ice tray unit 420 including a second ice tray 422. The second ice tray unit 420 may be provided to be movable relative to the first ice tray unit 410.

The first ice tray unit 410 and the second ice tray unit 420 may be supported by the support frame 450. The first ice tray unit 410 may be fixed to the support frame 450. The second ice tray unit 420 may be provided to be movable with respect to the support frame 450. Specifically, the second ice tray unit 420 may be provided to be movable between the first ice tray unit 410 and the second ejector 440.

The first ice tray unit 410 and the second ice tray unit 420 may be positioned at a position in which the first ice tray unit 410 and the second ice tray unit 420 are coupled to each other, or at a position in which the first ice tray unit 410 and the second ice tray unit 420 are separated from each other. According to the movement of the second ice tray unit 420, the first ice tray 412 and the second ice tray 422 may be coupled to each other while in contact with each other, or the first ice tray 412 and the second ice tray 422 may be separated from each other by moving away from each other.

When the first ice tray 412 and the second ice tray 422 are in contact with each other, the first ice tray 412 and the second ice tray 422 may form an ice making space for forming ice as one part.

Specifically, the first ice tray 412 may include a first ice making cell 412a. The first ice making cell 412a may be provided to receive water supplied from the water supply pipe 80. The first ice making cell 412a may be formed to have a shape recessed inwardly from the inner surface of the first ice tray 412.

In addition, the second ice tray 422 may include a second ice making cell 422a. The second ice making cell 422a may be provided to receive water supplied from the water supply pipe 80. The second ice making cell 422a may be provided to form a part of ice. The second ice making cell 422a may be formed to have a shape recessed inwardly from the inner surface of the second ice tray 422.

For example, as illustrated in FIG. 4, the first ice making cell 421a and the second ice making cell 422a may each be provided in plural. The plurality of first ice making cells 421a and the plurality of second ice making cells 422a may be provided in the same number, and each of the first ice making cells 421a may be arranged at a position corresponding to each of the second ice making cells 422a.

When the first ice tray 412 and the second ice tray 422 are coupled to each other, the first ice making cell 412a provided on the inner side of the first ice tray 412 and the second ice making cell 422a provided on the inner side of the second ice tray 422 may form a single ice making cell. Therefore, while the first ice tray 412 and the second ice tray 422 are coupled to each other, water may be supplied from the water supply pipe 80 to the inside of the first ice tray 412 and the second ice tray 422, and ice may be formed. For example, the single ice making cell formed by coupling the first ice making cell 412a and the second ice making cell 422a may have an approximately spherical shape.

The ice trays 412 and 422 may include inlet holes through which water is introduced from the water supply guide 460. Specifically, the first ice tray 412 may include a first inlet hole 412b, and the second ice tray 422 may include a second inlet hole 422b. When the first ice tray 412 and the second ice tray 422 are coupled to each other, the first inflow hole 412b and the second inflow hole 422b may be coupled to each other to form a single inflow hole. The inflow holes of the ice trays 412 and 422 may communicate with respective ice making cells. Water supplied from the water supply pipe 80 may be supplied to the ice making cell through the water supply guide 460 and the inflow hole.

After the ice formation in the first ice tray 412 and the second ice tray 422 is completed, the formed ice may be discharged from the ice trays 412 and 422 as the first ice tray 412 and the second ice tray 422 are separated from each other.

The first ice tray 412 may include a first contact portion 412e. The first contact portion 412e may be provided to contact the second ice tray 422 when the first ice tray 412 and the second ice tray 422 are coupled to each other.

For example, the first contact portion 412e of the first ice tray 412 may be formed along the periphery of the first ice making cell 412a.

The second ice tray 422 may include a second contact portion 422e. The second contact portion 422e may be provided to contact the first ice tray 412 when the first ice tray 412 and the second ice tray 422 are coupled to each other. That is, when the first ice tray 412 and the second ice tray 422 are coupled to each other, the first contact portion 412e and the second contact portion 422e may contact each other.

The second contact portion 422e of the second ice tray 422 may be formed along the periphery of the second ice making cell 422a.

For example, the first contact portion 412e and the second contact portion 422e may be formed to be engaged with each other. Accordingly, when the first ice tray 412 and the second ice tray 422 are coupled to each other, the coupling area may be sealed to prevent water from leaking from the ice making cells 412a and 422a.

As described above, when the first ice tray 412 includes a plurality of first ice making cells 412a and the second ice tray 422 includes a plurality of second ice making cells 422a, the first ice tray 412 may include a connecting portion 412d. The connecting portion 412d may be formed between the plurality of first ice making cells 412a such that water flowing into a portion of the plurality of first ice making cells 412a, which is connected to the first inflow hole 412b, may flow to the adjacent first ice making cells 412a. Correspondingly, the second ice tray 422 may also include a connecting portion formed between the plurality of second ice making cells 422b. That is, while the first ice tray 412 and the second ice tray 422 are coupled to each other, the plurality of ice making cells formed therein may be connected to each other.

The first ice tray unit 410 may include a first tray case 411. The first tray case 411 may support the first ice tray 412. At least a portion of the first ice tray 412 may be accommodated in the first tray case 411.

The first tray case 411 may include a first ice tray accommodating portion 411a. The first ice tray accommodating portion 411a may be provided to accommodate a portion of the first ice tray 412. The first ice tray accommodating portion 411a may be partition to correspond in number to the number of first ice making cells 412a.

The first tray case 411 may include a first through hole 411b. The first through hole 411b may be formed in a central portion of the first ice tray accommodating portion 411a that has been cut out. The first through hole 411b may be formed to allow a first pressing portion 432 of the first ejector 430 to pass therethrough.

The first ice tray unit 410 may include a first tray frame 413. The first tray frame 413 may support the first ice tray 412. The first tray frame 413 may contact the first ice tray 412. For example, the first tray frame 413 may contact the periphery of the first ice tray 412. The first tray frame 413 may be formed along the periphery of the first ice tray 412.

The first tray frame 413 may include a first ice making cell cover portion 413aformed along the periphery of the first ice making cell 412a. The first ice making cell cover portion 413a may cover the outer circumference of the first ice tray 412.

For example, while the first ice tray 412 and the second ice tray 422 are coupled to each other, the first ice making cell cover portion 413a may cover both the periphery of the first ice tray 412 and the periphery of the second ice tray 422. In this case, the first ice making cell cover portion 413a may be formed along a periphery of a portion in which the first ice making cell 412a and the second ice making cell 422a contact each other. That is, the first ice making cell cover portion 413a may cover the periphery of a region in which the first ice tray 412 and the second ice tray 422 are coupled to each other. That is, the first ice making cell cover portion 413a may cover the outer circumferences of the first contact portion 412e and the second contact portion 422e.

The first tray frame 413 has an opening, and the first ice making cell cover portion 413a may be formed to surround the opening. Accordingly, the first ice tray 412 may face the second ice tray 422 through the opening of the first tray frame 413, and may be coupled to the second ice tray 422.

The first tray frame 413 may be provided to fix the first ice tray 412 to the first tray case 411. The first tray frame 413 may be coupled to the first tray case 411. The first tray frame 413 and the first tray case 411 may be coupled to each other to thereby fix the first ice tray 412.

The first tray frame 413 and the first tray case 411 may be coupled to each other to thereby support the first ice tray 412. The first ice tray 412 may be fixed with a portion thereof disposed between the first tray frame 413 and the first tray case 411.

In detail, the first tray frame 413 may include a first fixing portion 413b that is provided to be fixed to the first tray case 411 and the first ice tray 412. The first ice tray 412, the first tray case 411, and the first tray frame 413 may be coupled to each other by a fastening member (not shown) that penetrates the first fixing portion 413b. With such a configuration, the first tray case 411, the first ice tray 412, and the first tray frame 413 may be fixed to each other.

The configuration of the first ice tray unit 410 is not limited to that described above, and the first ice tray unit 410 may include the first ice tray 412 and various configurations for supporting the first ice tray 412.

The second ice tray unit 420 may include a second tray case 421. The second tray case 421 may support the second ice tray 422. At least a portion of the second ice tray 422 may be accommodated in the second tray case 421.

The second tray case 421 may include a second ice tray accommodating portion 421a. The second ice tray accommodating portion 421a may be provided to accommodate a portion of the second ice tray 422. The second ice tray accommodating portion 421a may be partition to correspond in number to the number of second ice making cells 422a.

The second tray case 421 may include a second through hole 421b. The second through hole 421b may be formed in a central portion of the second ice tray accommodating portion 421a that has been cut out. The second through hole 421b may be formed to allow a second presser 442 of the second ejector 440 to pass therethrough.

The second tray case 421 may include a first elastic member mounting portion 421c. The first elastic member mounting portion 421c may be provided such that an elastic member 475 is connected thereto. One end of the elastic member 475 may be connected to the first elastic member mounting portion 421c of the second tray case 421, and the other end of the elastic member 475 may be connected to a second elastic member mounting portion 474c of the rack gear 474. Accordingly, when the rack gear 474 moves horizontally, the second tray case 421 may also move together with the movement.

The second tray case 421 may include a protrusion portion 421d. The protrusion portion 421d may be accommodated in a protrusion accommodation space 433a formed in the leg portion 433 of the first ejector 430. The protrusion portion 421d of the second tray case 421 may be provided to move the first ejector 430 in conjunction with the movement of the second tray case 421. Details thereof will be described below.

The second ice tray unit 420 may include a second tray frame 423. The second tray frame 423 may support the second ice tray 422. The second tray frame 423 may contact the second ice tray 422. For example, the second tray frame 423 may be formed along the periphery of the second ice tray 422.

The second tray frame 423 may include a second ice making cell cover portion 423a formed along the periphery of the second ice making cell 423a. The second ice making cell cover portion 423a may cover a portion of the outer circumference of the second ice tray 422.

Meanwhile, according to the embodiment illustrated in FIGS. 4 and 5, when the first ice tray 412 and the second ice tray 422 are coupled to each other, the first ice making cell cover portion 413a may be configured to cover both the periphery of the first ice tray 412 and the periphery of the second ice tray 422 as described above, but alternatively, the second ice making cell cover portion 423a may be configured to cover both the periphery of the first ice tray 412 and the periphery of the second ice tray 422. In this case, the second ice making cell cover portion 423a may be formed along the periphery of a portion in which the first ice making cell 412a and the second ice making cell 422a contact each other. That is, the second ice making cell cover portion 423a may cover the periphery of a region in which the first ice tray 412 and the second ice tray 422 are coupled to each other. That is, the second ice making cell cover portion 423a may cover the outer circumferences of the first contact portion 412e and the second contact portion 422e.

The second tray frame 423 has an opening, and the second ice making cell cover portion 423a may be formed to surround the opening. Accordingly, the second ice tray 422 may face the first ice tray 412 through the opening of the second tray frame 423 and may be coupled to the first ice tray 412.

The second tray frame 423 may be provided to fix the second ice tray 422 to the second tray case 421. The second tray frame 423 may be coupled to the second tray case 421. The second tray frame 423 and the second tray case 421 may be coupled to each other, to thereby fix the second ice tray 422.

The second tray frame 423 and the second tray case 421 may be coupled to each other, to thereby support the second ice tray 422. The second ice tray 422 may be fixed with a portion thereof disposed between the second tray frame 423 and the second tray case 421.

In detail, the second tray frame 423 may include a second fixing portion 423b that is provided to be fixed to the second tray case 421 and the second ice tray 422. The second ice tray 422, the second tray case 421, and the second tray frame 423 may be coupled to each other by a fastening member (not shown) that penetrates the second fixing portion 423b. With such a configuration, the second tray case 421, the second ice tray 422, and the second tray frame 423 may be fixed to each other, and may be moved together.

The configuration of the second ice tray unit 420 is not limited to that described above, and the second ice tray unit 420 may include the second ice tray 422 and various configurations for supporting the second ice tray 422.

The ice making unit 400 may include a driver 470 that provides power for moving the second ice tray unit 420 relative to the first ice tray unit 410, and ejectors 430 and 440 that discharge ice formed in the ice trays 412 and 422 from the ice trays 412 and 422.

The driver 470 may include a motor (not shown) that generates power, a motor case 471 that accommodates the motor, and power transmission members 472, 473, and 474 that transmit power generated from the motor.

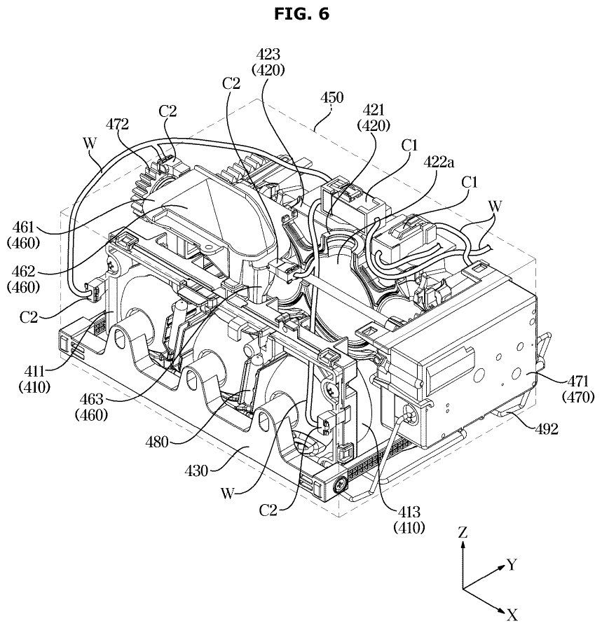

The driver 470 may be electrically connected to a controller (50 in FIG. 11) described below. Specifically, the motor of the driver 470 may be electrically connected to the controller 50, and the controller 50 may control the operation of the motor. For example, the motor of the driver 470 may be electrically connected to the controller 50 through a wire W. In this case, the motor of the driver 470 may be electrically connected to the controller 50 through a part of the wire W connected to the intermediate connector C1 (see FIG. 6).

The motor case 471 may be coupled to the support frame 450. In detail, the motor case 471 may be coupled to the outer surface of one side of the support frame 450.

The power transmission members 472, 473, and 474 may be connected to the motor of the driver 470 and may receive power generated by the motor. The power transmission members 472, 473, and 474 may transmit the power received from the motor to the second ice tray unit 420. For example, the power transmission members 472, 473, and 474 may include at least one gear.

The power transmission members 472, 473, and 474 may be provided to convert rotary motion by the motor of the driver 470 into linear motion and transmit the linear motion to the second ice tray unit 420.

For example, the power transmission members 472, 473, and 474 may include a pinion gear 472 and a rack gear 474. The pinion gear 472 may be connected to a rotating shaft of the motor of the driver 470. The pinion gear 472 may be rotated by receiving power from the motor of the driver 470. The pinion gear 472 may be engaged with the rack gear 474, and the rotary motion of the pinion gear 472 may be converted into linear motion of the rack gear 474.

The rack gear 474 may be coupled to the second ice tray unit 420. The second ice tray unit 420 may be provided to linearly move with respect to the first ice tray unit 410 by the linear motion of the rack gear 474.

The driver 470 may further include an elastic member 475. The rack gear 474 may be connected to the second tray case 421 through the elastic member 475. For example, the elastic member 475 may include an elastic spring.

The rack gear 474 may include a toothed portion 474a formed to be engaged with the pinion gear 472. The rack gear 474 may include a support portion 474b supported by the support frame 450. For example, the toothed portion 474a may be formed on an upper surface of the support portion 474b.

The toothed portion 474a of the rack gear 474 may be engaged with the pinion gear 472. Accordingly, when the pinion gear 472 rotates, the rack gear 474 may move horizontally with respect to the support frame 450.

The rack gear 474 may include a second elastic member mounting portion 474c extending from the support portion 474b. The elastic member 475 may be mounted on the second elastic member mounting portion 474c.

When the rack gear 474 receives power generated from the driver 470 from the pinion gear 472 and moves horizontally, the second tray case 421 may also move horizontally. The second tray case 421, the second ice tray 422, and the second tray frame 423 may move together in combination with each other. As described above, as the second ice tray unit 420 moves to be separated from the first ice tray unit 410, ice formed between the first ice tray 412 and the second ice tray 422 may be separated from the first ice tray 412 and the second ice tray 422.

In addition, as described above, the rack gear 474 and the second tray case 421 may be connected by the elastic member 475. When the second tray case 421 moves toward the first tray case 411 and the first ice tray 412 and the second ice tray 422 are engaged with each other, the rack gear 474 may be further moved in the direction of the first ice tray 412 by the elastic force of the elastic member 475. Accordingly, the first ice tray 412 and the second ice tray 422 may be coupled together in closer contact with each other.

The pinion gear 472 may be provided in plural to be arranged on each side of the support frame 450. The driver 470 may include a shaft member 473 provided to connect the plurality of pinion gears 472. The shaft member 473 may be provided to transmit the rotation of the pinion gear 472 on one side to the pinion gear 472 on the other side. The shaft member 473 may be provided in an approximate bar shape.

However, the configuration of the driver 470 described above is only an example of a configuration that may provide power for moving the second ice tray unit 420 relative to the first ice tray unit 410. The concept of the disclosure is not limited thereto, and for example, the driver 470 may include various configurations that may transmit power generated from a power source.

The ejectors 430 and 440 of the ice making unit 400 may include a first ejector 430 and a second ejector 440. The first ejector 430 may be provided at a position adjacent to the first ice tray unit 410. The second ejector 440 may be provided at a position adjacent to the second ice tray unit 420. The first ice tray unit 410 and the second ice tray unit 420 may be arranged between the first ejector 430 and the second ejector 440.

The first ejector 430 may be provided to be movable relative to the support frame 450. The first ejector 430 may be provided to be movable based on the movement of the second ice tray unit 420.

The first ejector 430 may include a first body 431, a first pressing portion 432, and a leg portion 433.

The first body 431 may be formed to extend in a direction parallel to the first tray case 411. That is, the first body 431 may be formed to extend in a direction perpendicular to a direction in which the first ejector 430 moves.

The first pressing portion 432 may be formed to extend from the first body 431. The first body 431 may support the first pressing portion 432.

The first pressing portion 432 may be provided to pass through the first through hole 411b of the first tray case 411 to press the first ice tray 412. The number of first pressing portions 432 may correspond to the number of first ice making cells 412a.

The first ice tray 412 may be provided to be elastically deformable. For example, the first ice tray 412 may include an elastically deformable material, such as silicone or rubber. Accordingly, when the first pressing member 432 presses the first ice tray 412, the shape of the first ice making cell 412a may be deformed.

The leg portions 433 may be formed to extend from both ends of the first body 431 and inserted into side portions of the support frame 450. More specifically, the leg portions 433 may be supported by the leg support portions 452c of the support frame 450. The leg portions 433 may extend in a direction parallel to a direction in which the first ejector 430 moves. The leg portions 433 may be provided as a pair of leg portions symmetrical to each other at both ends of the first body 431.

When the second ice tray unit 420 moves in a direction away from the first ice tray unit 410, the first ejector 430 may move in the direction in which the second ice tray unit 420 moves. That is, since the first ice tray unit 410 is disposed between the first ejector 430 and the second ice tray unit 420, the first ejector 430 may move in a direction toward the first ice tray unit 410.

In addition, when the second ice tray unit 420 moves in a direction toward the first ice tray unit 410, the first ejector 430 may also move in the direction in which the second ice tray unit 420 moves. That is, since the first ice tray 412 is disposed between the first ejector 430 and the second ice tray unit 420, the first ejector 430 may move in a direction away from the first ice tray unit 410.

For example, the leg portion 433 may be provided to accommodate the protrusion portion 421d of the second tray case 421. A protrusion accommodation space 433a may be formed on the inside of the leg portion 433. The protrusion portion 421d of the second tray case 421 may be accommodated in the protrusion accommodation space 433a of the leg portion 433 and interfere with the leg portion 433. According to the movement of the second ice tray unit 420, the protrusion portion 421d of the second tray case 421 and the leg portion 433 may interfere with each other, allowing the first ejector 430 to also move together.

The second ejector 440 may include a second body 441, a second pressing portion 442, and a frame mounting portion 443.

The second body 441 may be formed to extend in a direction parallel to the second tray case 421. That is, the second body 441 may be formed to extend in a direction perpendicular to a direction in which the second tray case 421 moves. The second body 441 may be formed to extend while connecting both side surfaces of the second support frame 452.

The second presser 442 may be formed to extend from the second body 441. The second presser 442 may be formed to extend toward the second ice tray 422. The second body 441 may support the second pressing portion 442.

The second presser 442 may be provided to pass through the second through hole 421b of the second tray case 421 to press the second ice tray 422. The number of second pressers 442 may correspond to the number of second ice making cells 422a.

The second ice tray 422 may be provided to be elastically deformable. For example, the second ice tray 422 may include an elastically deformable material, such as silicone or rubber. Accordingly, when the second pressing member 442 presses the second ice tray 422, the shape of the second ice making cell 422a may be deformed.

The second ejector 440 may be fixed to one side of the support frame 450.

The frame mounting portion 443 may be provided at a position corresponding to the ejector mounting portion 452d of the second support frame 452. The frame mounting portions 443 may be formed at both ends of the second body 441. The second ejector 440 may be mounted to one side of the second support body 452a through the frame mounting portions 443. That is, the second ejector 440 may be coupled to the second support frame 452.

The second ejector 440 may be fixed with respect to the support frame 450 and when the second ice tray unit 420 moves toward the second ejector 440, press the second ice tray 422. More specifically, the second ejector 440 may be provided to press the second ice making cell 422a of the second ice tray 422 when the second ice tray unit 420 moves toward the second ejector 440.

Hereinafter, the operation of the ice making unit 400 during an ice making operation and an ice-removing operation will be described.

As described above, the first ice tray 412 and the second ice tray 422 may be coupled to or separated from each other.

When the ice trays 412 and 422 form ice using water supplied from the water supply pipe 80, the first ice tray 412 and the second ice tray 422 may be coupled to each other.

After ice formation is completed, the second ice tray unit 420 including the second ice tray 422 may be separated from the first ice tray unit 410 including the first ice tray 412 and moved linearly toward the second ejector 440.

The second pressing portion 442 of the second ejector 440 may, in response to the approach of the second ice tray unit 420, press the second ice making cell 422a by passing through the second tray case 421. In this case, the second ice making cell 422a may be elastically deformed, and ice located inside the second ice making cell 422a may be discharged from the second ice tray 422. The ice discharged from the second ice tray 422 may be moved to the ice bucket 100.

When the second ice tray unit 420 moves further in the same direction while the second ice tray 422 is pressed by the second presser 442, the protrusion portion 421d of the second tray case 421 interferes with the leg portion 433 of the first ejector 430, causing the first ejector 430 to move toward the first ice tray 412. Accordingly, the first pressing portion 432 of the first ejector 430 may penetrate the first tray case 411 to press the first ice tray 412. In this case, the first ice making cell 412a may be elastically deformed, and ice, disposed in the first ice making cell 412a rather than the second ice making cell 422a, may be discharged from the first ice tray 412. The ice discharged from the first ice tray 412 may be moved to the ice bucket 100.

With such a configuration, ice formed in the ice trays 412 and 422 may be discharged from the ice trays 412 and 422, and moved to the ice bucket 100 in the ice-moving operation.

Meanwhile, when it is desired to discharge ice from the ice trays 412 and 422 as described above, but the ice is stuck to the inner surface of the ice trays 412 and 422, the ice-removing operation may not proceed smoothly. In particular, when freezing of water occurs in the region in which the first ice tray 412 and the second ice tray 422 are coupled to each other, that is, the first contact portion 412e and the second contact portion 422e, the second ice tray 422 may not be smoothly separated from the first ice tray 412, in which case the ice-removing operation may not proceed smoothly. In addition, even after the ice is discharged from the ice trays 412 and 422, some ice may remain in the ice trays 412 and 422.

Furthermore, in a process of supplying water to the ice trays 412 and 422, the water passes through the water supply guide 460, which may cause ice formation in the water supply guide 460. When ice formation occurs in the water supply guide 460, the subsequent water supply process may not proceed smoothly.

In order to resolve the issues, the first tray frame 413 included in the ice maker 200 of the refrigerator 1 according to the embodiment of the disclosure may be provided to generate heat. Hereinafter, for the convenience of description, the first tray frame 413 may be referred to as a “tray frame 413”.

In addition, the water supply guide 460 included in the ice maker 200 of the refrigerator 1 according to the embodiment of the disclosure may be provided to generate heat.

Hereinafter, the structures of the tray frame 413 and the water supply guide 460 are described in detail.

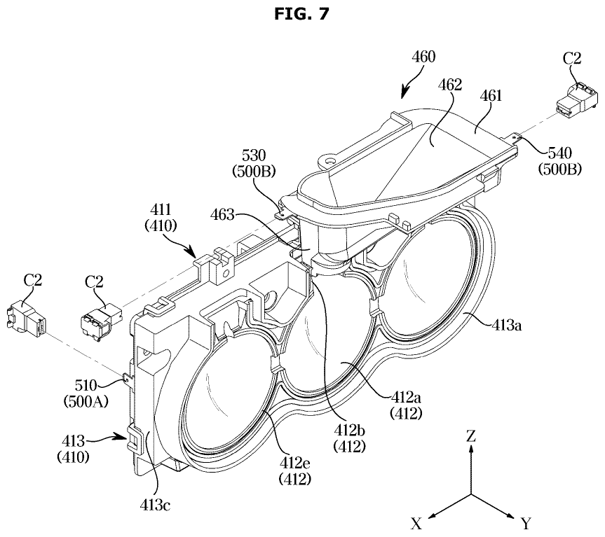

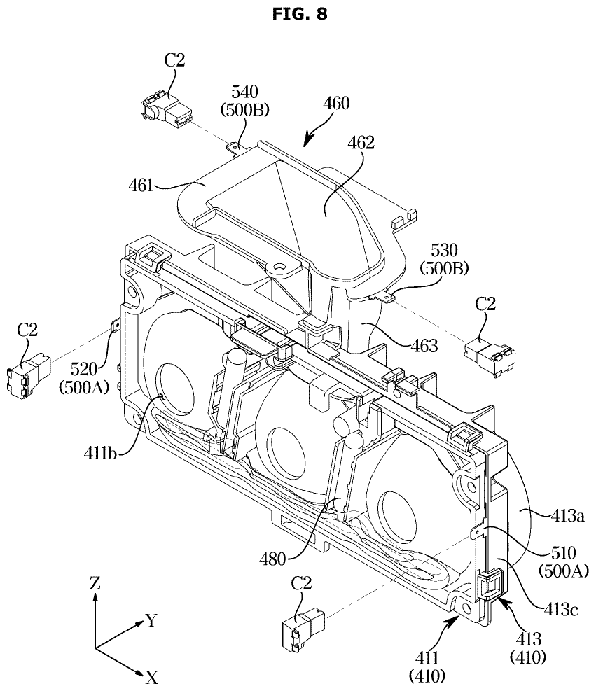

FIG. 6 is a view illustrating an ice making unit of a refrigerator according to an embodiment of the disclosure. FIG. 7 is a view illustrating some components of an ice making unit of a refrigerator according to an embodiment of the disclosure. FIG. 8 is a view illustrating some components of an ice making unit of a refrigerator according to an embodiment of the disclosure.

Referring to FIGS. 6 to 8, the ice maker 200 of the refrigerator 1 according to an embodiment of the disclosure may include the tray frame 413 that supports the first ice tray 412. The tray frame 413 may be provided to generate heat for heating the ice trays 412 and 422.

The tray frame 413 may be provided to generate heat upon current flowing therethrough. In other words, the tray frame 413 may be provided to generate heat upon a voltage being applied thereto.

Specifically, the tray frame 413 may include a material that generates heat when current flows through the material. The tray frame 413 may include a conductive material that, when a voltage is applied thereto, allows current to flow therethrough and generates heat by resistance as the current flows. Due to the material, when a voltage is applied to the tray frame 413, current may flow through the tray frame 413, and the tray frame 413 may generate heat due to the resistance caused by the current. The material of the tray frame 413 may referred to as a ‘heat-generating material’.

For example, the material included in the tray frame 413 and generating heat when current flows therethrough may include a carbon nanotube (CNT) material.

Carbon nanotubes are an allotropy of carbon with a cylindrical nanostructure, and have a tube structure in which a plurality of carbon atoms are combined in a hexagonal honeycomb pattern. Carbon nanotubes have very high thermal conductivity and very high electrical conductivity.

When a voltage is applied to carbon nanotubes, current flows through the carbon nanotubes, and heat may be generated due to the resistance of the carbon nanotubes. In addition, due to the high electrical conductivity, the carbon nanotubes exhibit low power consumption when voltage is applied, while the heat generation efficiency is relatively high. In addition, with the high thermal conductivity, carbon nanotubes also have excellent heat transfer efficiency.

Since the tray frame 413 includes a carbon nanotube material having such characteristics, applying a voltage to the tray frame 413 may cause current to flow through the tray frame, resulting in heat generation due to resistance. In addition, since the tray frame 413 includes carbon nanotubes as a material for generating heat, power consumption is reduced during heat generation, and the thermal efficiency is also high, allowing the ice trays 412 and 422 to be efficiently heated.

For example, the tray frame 413 may include a composite material of carbon nanotubes and polymer using polymer as a matrix. The tray frame 413 may be formed using a composite material of carbon nanotubes and polymer through an injection molding process.

The polymer included in the tray frame 413 may include various types of polymer resins, such as nylon, polypropylene (PP), and polyethylene.

The disclosure is not limited thereto, and the tray frame 413 may include various types of materials that may allow current to flow therethrough when a voltage is applied thereto and generate heat when current flows therethrough.

Since the tray frame 413 includes a conductive material, the tray frame 413 may include a coating layer that covers the outer surface of a portion corresponding to the conductive material of the tray frame 413 to protect peripheral components of the tray frame 413 or to protect the tray frame 413 and components electrically connected to the tray frame 413 from the peripheral components. The coating layer of the tray frame 413 may form the outer surface of the tray frame 413.

The coating layer may include a material having high electrical insulation properties. In addition, the coating layer may include a material having high water repellency. For example, the coating layer may include materials such as silicone, polyurethane, etc., but the type of the materials forming the coating layer is not limited thereto.

In addition, the coating layer may be formed of a material that is not affected by contact with food or is harmless to the human body.

Since the tray frame 413 may be provided to generate heat based on the voltage applied thereto, the tray frame 413 may include a terminal 500A that is provided to apply a voltage to the tray frame 413. The terminal 500A included in the tray frame 413 may be referred to as a “frame terminal 500A”.

For example, the frame terminal 500A may include various types of conductive materials such as copper, a copper-nickel alloy, a copper-tin alloy, silver-plated copper, and an copper-magnesium alloy.

In detail, the frame terminal 500A may include a pair of frame terminals 510 and 520 provided to apply a voltage to the tray frame 413. For the sake of convenience of description, between the frame terminals 510 and 520, one frame terminal 510 positioned at the front in the X direction with reference to FIGS. 7 and 8 may be referred to as a first terminal 510, and the other frame terminal 520 may be referred to as a second terminal 520.

The tray frame 413 may include a frame body 413c. The frame body 413c may support the ice tray 412. For example, the first ice making cell cover portion 413a described above may be formed integrally with the frame body 413c. For example, the first fixing portion 413b described above may be formed integrally with the frame body 413c. The frame body 413c, a part of the tray frame 413, may include a conductive material and be configured to generate heat when current flows therethrough. For example, the frame body 413c may include a carbon nanotube CNT material.

The frame terminal 500A may be connected to the frame body 413c. The frame terminal 500A may be electrically connected to the frame body 413c. The frame terminal 500A may be directly connected to the frame body 413c. The frame terminal 500A may be coupled to the frame body 413c. The frame terminal 500A may be coupled to the frame body 413c and electrically connected to the frame body 413c. However, alternatively, in an embodiment, the frame terminal 500A may be directly coupled to the first ice making cell cover portion 413a.

As to be described below, the frame terminal 500A may be connected to a terminal connector C2. In order for the terminal connector C2 to be easily connected to the frame terminal 500A, the frame terminal 500A may be coupled to a side of the frame body 413c that is opposite to the second ice tray 422. In other words, the frame terminal 500A may be disposed to face in a direction opposite to a direction toward the second ice tray 422 with respect to the frame body 413c.

For example, the frame terminal 500A may be disposed to face in a parallel direction with respect to the frame body 413c (e.g., the Y direction) based on the drawing, and the terminal connectors C2 may be coupled to the frame terminals 500A in the parallel direction.

One of the frame terminals 500A s may be coupled to one side of the frame body 413c, and the other one of the frame terminals 500A may be coupled to the other side of the frame body 413c. For example, as illustrated in FIG. 8, a first terminal 510 of the frame terminals 500A may be coupled to one side of the frame body 413c in the longitudinal direction e.g., in the X direction based on the drawing, and a second terminal 520 of the frame terminals 500A may be coupled to the other side of the frame body 413c in the longitudinal direction.

Here, it may be assumed that a plurality of first ice making cells 412a in the first ice tray 412 are arranged along the longitudinal direction of the frame body 413c for example, in the X direction based on the drawing. In this case, the first terminal 510 between the frame terminals 500A may be arranged adjacent to one of the plurality of first ice making cells 412a that is located at one end of the frame body 413c in the longitudinal direction, for example, located at the foremost end of the frame body 413c based on the drawing. In addition, the second terminal 520 between the frame terminals 500A may be arranged adjacent to one of the plurality of first ice making cells 412a that is located at the other end of the frame body 413c in the longitudinal direction, for example, located at the rearmost end of the frame body 413c based on the drawing.

With such a structure, the first terminal 510 and the second terminal 520 may be arranged at positions far apart from each other on the frame body 413c. Accordingly, a uniform current is caused to flow across approximately the entire area of the tray frame 413 when a voltage is applied between the first terminal 510 and the second terminal 520, and the uniformity of heat generation in the tray frame 413 may be improved.

However, the disclosure is not limited thereto, and the frame terminal 500A may be coupled to various positions of the frame body 413c.

The refrigerator 1 may include a power supply (600 in FIG. 11) electrically connected to the frame terminal 500A. Specifically, the power supply 600 may be provided to apply a voltage to the frame terminal 500A electrically connected to the frame body 413c. The power supply 600 may be provided to apply a voltage between the first terminal 510 and the second terminal 520. In other words, the power supply 600 may be provided to apply a voltage for causing current to flow through the tray frame 413. The power supply 600 may be provided to apply a voltage to the frame terminal 500A under control of the controller (50 in FIG. 11). The power supply 600 may generate a potential difference between the first terminal 510 and the second terminal 520, or may remove the potential difference.

For example, the power supply 600 may be provided to apply a constant voltage to the frame terminal 500A. Alternatively, the power supply 600 may be provided to apply a variable voltage to the frame terminal 500A.

For example, the power supply 600 may be connected to an external power source and may receive power from the external power source. Alternatively, for example, the power supply 600 may be connected to a battery that charges power and may receive power.

For example, the power supply 600 may be configured to include electronic components for applying a voltage between the terminals 500 and a printed circuit board on which the electronic components are mounted.

The frame terminal 500A may be electrically connected to the power supply 600 by a wire W. Specifically, the refrigerator 1 may include a terminal connector C2 that is electrically connected to the power supply 600 by a wire W, and the terminal connector C2 may be connected to each of the frame terminals 500A. The terminal connector C2 may be connected to the frame terminal 500A to electrically connect the power supply 600 and the frame terminal 500A. The terminal connector C2 may be provided in plural, and the number of the plurality of terminal connectors C2 and the number of the plurality of frame terminals 500A may correspond to each other.

Taking as an example the case illustrated in FIG. 6, the terminal connectors C2 may be electrically connected to wires W extending from the outside of the ice maker 200. Specifically, some of the wires W extending from the outside of the ice maker 200 may be connected to the intermediate connectors C1, and some of the wires W connected to the intermediate connectors C1 may be connected to the terminal connectors C2. Alternatively, the terminal connectors C2 may be directly connected to the wires W extending from the outside of the ice maker 200.

The terminal connectors C2 may be detachably coupled to the frame terminals 500A.

As described above, the tray frame 413 may have a fixed position. The tray frame 413 may have a fixed position together with the first ice tray 412.

While the components of the second ice tray unit 420 are provided to be movable with respect to the components of the first ice tray unit 410, since the tray frame 413 has a fixed position, the frame terminals 500A and the terminal connectors C2 connected thereto may be stably connected to each other, and the wires W connected to the terminal connectors C2 may also have a stable position.

As described above, the tray frame 413 may be in contact with the outer surface of the first ice tray 412. In particular, the tray frame 413 may be in contact with the periphery of the first ice tray 412. In addition, as an example, the tray frame 413 may also be in contact with the periphery of the second ice tray 422. With such a configuration, when heat is generated in the tray frame 413, the heat may be transferred to the ice trays 412 and 422.

The tray frame 413 may be provided to heat a region in which the first ice tray 412 and the second ice tray 422 come into contact with each other when the first ice tray 412 and the second ice tray 422 are coupled to each other.

In detail, the tray frame 413 may cover the outer circumstance of the first contact portion 412e. As described above, the tray frame 413 may include the first ice making cell cover portion 413a, and when current flows through the first ice making cell cover portion 413a, heat generated in the first ice making cell cover portion 413a may be more efficiently transferred to the first contact portion 412e.

With such a configuration, when heat is generated in the tray frame 413, the heat may be efficiently transferred to the region in which the first ice tray 412 and the second ice tray 422 come into contact with each other.

As described above, the ice maker 200 includes the tray frame 413 including a material configured to generate heat when current flows therethrough, and thus, may efficiently discharge the produced ice after ice making is completed by heating the ice trays 412 and 422 using the tray frame 413. In addition, the ice maker 200 may efficiently remove the remaining ice in the ice trays 412 and 422 after the ice is discharged from the ice trays 412 and 422.

In addition, the ice maker 200 may heat the ice trays 412 and 422 without having a separate heater by using the tray frame 413 that generates heat when current flows therethrough. Since the tray frame 413 includes a material that generates heat when current flows therethrough, heat generation occurs across approximately the entire area, so that the ice trays 412 and 422 may be heated more efficiently, and unlike a general heater, even when a part of the tray frame 413 is damaged, heat may be generated in the remaining part. In addition, the heat generated in the tray frame 413 may be efficiently transferred to the ice.

Referring to FIGS. 6 to 8, the ice maker 200 of the refrigerator 1 according to an embodiment of the disclosure may include a water supply guide 460 that is provided to guide water to the ice trays 412 and 422. Water flowing along the water supply guide 460 may flow into the ice making cells 412a and 422a. The water supply guide 460 may be provided to generate heat to prevent freezing of water in the water supply guide 460.

The water supply guide 460 may be provided to generate heat when current flows therethrough. In other words, the water supply guide 460 may be provided to generate heat when a voltage is applied thereto.

In detail, the water supply guide 460 may include a material that generates heat when current flows through the material. The water supply guide 460 may include a conductive material that allows current to flow therethrough when a voltage is applied thereto, and generates heat due to resistance as the current flows therethrough. Due to the material, when a voltage is applied to the water supply guide 460, current may flow through the water supply guide 460, and the water supply guide 460 may generate heat due to resistance caused by the current. The material of the water supply guide 460 may referred to as a ‘heat-generating material’.

Similar to the tray frame 413, for example, the material included in the water supply guide 460 and generating heat when current flows therethrough may include a carbon nanotube CNT material.

In addition, similar to the tray frame 413, the water supply guide 460 may include a composite material of carbon nanotubes and polymers using a polymer as a matrix. The water supply guide 460 may be formed using a composite material of carbon nanotubes and polymers through an injection molding process.

The polymer included in the water supply guide 460 may include various types of polymer resins, such as nylon, polypropylene (PP), and polyethylene.

The disclosure is not limited thereto, and the water supply guide 460 may include various types of materials that may allow current to flow therethrough when a voltage is applied thereto and generate heat when current flows therethrough.

The water supply guide 460 may include a coating layer that covers the outer surface of a portion corresponding to the conductive material of the water supply guide 460. The coating layer of the water supply guide 460 may form the outer surface of the water supply guide 460. The coating layer of the water supply guide 460 may have characteristics corresponding to the coating layer of the tray frame 413.

The water supply guide 460 may be provided to be separable from the first ice tray unit 410 including the tray frame 413. Furthermore, the water supply guide 460 may be electrically insulated from the tray frame 413.

Accordingly, the water supply guide 460 may include a terminal 500B to which a voltage is applied to generate heat separately from the tray frame 413. Specifically, the water supply guide 460 may include a terminal 500B provided to apply a voltage to the water supply guide 460. The terminal 500B included in the water supply guide 460 may be referred to as a “water supply guide terminal 500B”.

For example, the water supply guide terminal 500B may include various types of conductive materials such as copper, a copper-nickel alloy, a copper-tin alloy, silver-plated copper, and a copper-magnesium alloy.

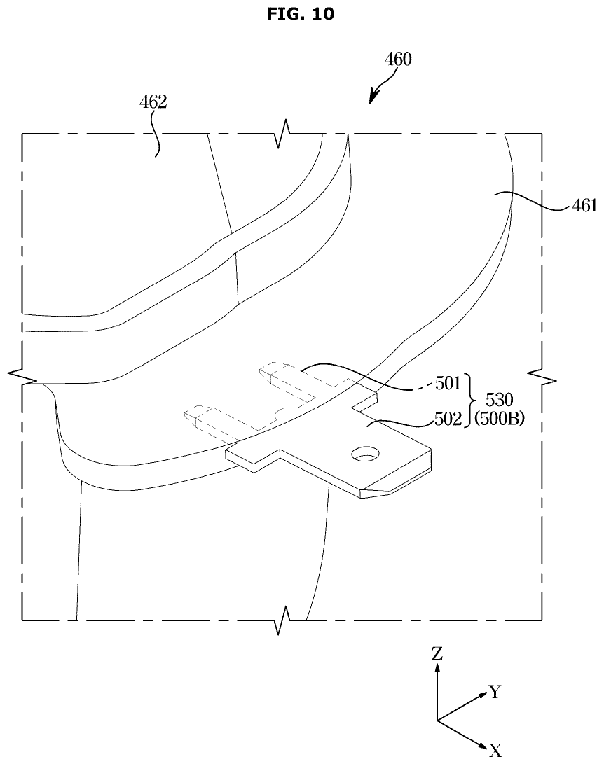

Specifically, the water supply guide terminal 500B may include a pair of water supply guide terminals 530 and 540 provided to apply a voltage to the water supply guide 460. For the sake of convenience of description, between the water supply guide terminals 500B, one water supply guide terminal 530 positioned at the front in the X direction based on FIGS. 10 and 11 may be referred to as a third terminal 530, and the other water supply guide terminal 540 may be referred to as a fourth terminal 540.

The water supply guide terminal 500B may be directly connected to the guide body 461. The water supply guide terminal 500B may be coupled to the guide body 461. The water supply guide terminal 500B may be coupled to the guide body 461 and electrically connected to the guide body 461.

As to be described below, the water supply guide terminal 500B may be connected to a terminal connector C2. In order for the terminal connector C2 to be easily connected to the water supply guide terminal 500B, the water supply guide terminal 500B may be provided in an upper portion of the water supply guide 460. That is, the water supply guide terminal 500B may be coupled to the upper portion of the guide body 461. Alternatively, in order for the terminal connector C2 to be easily connected to the water supply guide terminal 500B, the water supply guide terminal 500B may be provided on the periphery of the water supply guide 460. That is, the water supply guide terminal 500B may be coupled to the periphery of the guide body 461.

For example, the water supply guide terminal 500B may be disposed to face in a parallel direction with respect to the guide body 461 (e.g., the X direction) based on the drawing, and the terminal connectors C2 may be coupled to the water supply guide terminals 500B in the parallel direction.

One of the water supply guide terminals 500B may be coupled to one side of the guide body 461, and the other one of the water supply guide terminals 500B may be coupled to the other side of the guide body 461. Specifically, as shown in FIGS. 7 and 8, the third terminal 530 of the water supply guide terminal 500B may be coupled to one side of the periphery of the guide body 461, and the fourth terminal 540 may be coupled to the other side of the periphery of the guide body 461. In other words, the third terminal 530 and the fourth terminal 540 may be disposed at the opposite positions on the periphery of the guide body 461. As shown in FIGS. 7 and 8, the third terminal 530 and the fourth terminal 540 may be arranged opposite to each other at almost the same height, or, alternatively, the third terminal 530 and the fourth terminal 540 may be arranged at different heights.

With such a structure, the third terminal 530 and the fourth terminal 540 may be arranged at positions far apart from each other on the guide body 461. Accordingly, a uniform current is caused to flow across approximately the entire area of the water supply guide 460 when a voltage is applied between the third terminal 530 and the fourth terminal 540, and the uniformity of heat generation in the water supply guide 460 may be improved.

However, the disclosure is not limited thereto, and the water supply guide terminal 500B may be provided at various locations of the water supply guide 460.

The water supply guide terminal 500B may be electrically connected to the power supply (600 in FIG. 11). The power supply 600 may be provided to apply a voltage to the water supply guide terminal 500B. In other words, the power supply 600 may be provided to apply a voltage for current to flow through the water supply guide 460. The power supply 600 may be provided to apply a voltage to the water supply guide terminal 500B under control of the controller (50 in FIG. 11). The power supply 600 may generate a potential difference between the third terminal 530 and the fourth terminal 540, or may remove the potential difference.

For example, the power supply 600 may be provided to apply a constant voltage to the water supply guide terminal 500B. Alternatively, the power supply 600 may be provided to apply a variable voltage to the water supply guide terminal 500B.

Similar to the frame terminal 500A, the water supply guide terminal 500B may be electrically connected to the power supply 600 by a wire W. Specifically, the terminal connector C2 connected to the wire W may be connected to the water supply guide terminal 500B. The terminal connectors C2 may be connected to the water supply guide terminals 530 and 540 to electrically connect the power supply 600 and the water supply guide terminals 530 and 540.

Taking as an example the case illustrated in FIG. 6, the terminal connectors C2 connected to the water supply guide terminals 500B may be electrically connected to wires W extending from the outside of the ice maker 200. Specifically, some of the wires W extending from the outside of the ice maker 200 may be connected to the intermediate connectors C1, and some of the wires W connected to the intermediate connectors C1 may be connected to the terminal connectors C2, respectively. Alternatively, the terminal connectors C2 connected to the water supply guide terminals 500B may be directly connected to the wires W extending from the outside of the ice maker 200.

The terminal connectors C2 may be detachably coupled to the water supply guide terminals 500B.

As described above, the water supply guide 460 may be mounted on the support frame 450 and may be fixed in position. Therefore, the water supply guide terminals 500B and the terminal connectors C2 connected thereto may be stably connected to each other, and the wires W connected to the terminal connectors C2 may also have a stable position.

As described above, the ice maker 200 may include the water supply guide 460 including a material that generates heat when current flows therethrough, thereby preventing freezing of water on the water supply guide 460.

In addition, the ice maker 200 may generate heat on the water supply guide 460 without having a separate heater by using the water supply guide 460 that generates heat when current flows therethrough. Since the water supply guide 460 includes a material that generates heat when current flows therethrough, heat generation occurs across approximately the entire area, so that heat generation efficiency may be improved, and unlike a general heater, even when a part of the water supply guide 460 is damaged, heat may be generated in the remaining part. In addition, the heat generated in the water supply guide 460 may be efficiently transferred to the ice.

The power supply (600 in FIG. 11) may be configured to independently apply voltages to the frame terminal 500A and the water supply guide terminal 500B, or may be configured to apply voltages to the frame terminal 500A and the water supply guide terminal 500B simultaneously in a dependent manner.

The frame terminal 500A and the water supply guide terminal 500B may be connected to one power supply 600 or may be connected to different power supplies 600 that are separate modules.

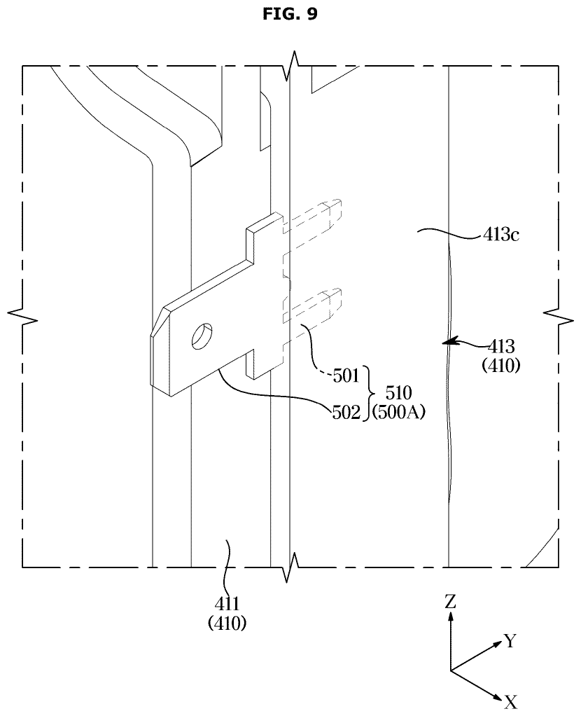

FIG. 9 is an enlarged view illustrating a tray frame and terminals included in an ice maker of a refrigerator according to an embodiment of the disclosure. FIG. 10 is an enlarged view illustrating a water supply guide and terminals included in an ice maker of a refrigerator according to an embodiment of the disclosure.

Referring to FIGS. 9 and 10, a part of the frame terminal 500A may be inserted into the frame body 413c. In addition, a part of the water supply guide terminal 500B may be inserted into the guide body 461. In FIGS. 9 and 10, only the first terminal 510 and the third terminal 530 are illustrated, but the following description may be equally applied to the second terminal 520 and the fourth terminal 540.

As illustrated in FIG. 9, a part of the frame terminal 500A may be inserted into the frame body 413c. With the part of the frame terminal 500A being inserted into the frame body 413c, the frame terminal 500A may be coupled to the frame body 413c.

The frame terminal 500A may include an insertion portion 501 inserted into the frame body 413c and a connecting portion 502 extending from the insertion portion 501 to the outside of the frame body 413c.

The terminal connector C2 described above may be connected to the connecting portion 502. The terminal connector C2 may be coupled to the connecting portion 502. For example, the connecting portion 502 may be inserted into the terminal connector C2 and connected to the terminal connector C2. As a result, the frame terminal 500A may be electrically connected to the power supply 600.

For example, the tray frame 413 may be formed by insert molding while the insertion portion 501 is inserted into the frame body 413c.

As illustrated in FIG. 10, a part of the water supply guide terminal 500B may be inserted into the guide body 461. With the part of the water supply guide terminal 500B being inserted into the guide body 461, the water supply guide terminal 500B may be coupled to the guide body 461.

The water supply guide terminal 500B may include an insertion portion 501 inserted into the guide body 461 and a connecting portion 502 extending from the insertion portion 501 to the outside of the guide body 461.

The terminal connector C2 described above may be connected to the connecting portion 502. The terminal connector C2 may be coupled to the connecting portion 502. For example, the connecting portion 502 may be inserted into the terminal connector C2 and connected to the terminal connector C2. As a result, the water supply guide terminal 500B may be electrically connected to the power supply 600.

With such a configuration, the terminal 500A or 500B may be connected to the frame body 413c or the guide body 461, and may be connected to the power supply 600 through the terminal connector C2.

However, the structure of the frame terminal 500A or the water supply guide terminal 500B described with reference to FIGS. 9 and 10 is only an example, and the terminal 500A or 500B may be electrically connected to the frame body 413c or the guide body 461 in various ways.

FIG. 11 is a block diagram illustrating some components of a refrigerator according to an embodiment of the disclosure.

Referring to FIG. 11, the refrigerator 1 according to an embodiment of the disclosure may include a controller 50 that controls various components of the refrigerator 1.

The controller 50 may include a processor 51 that generates a control signal regarding the operation of the refrigerator 1, and a memory 52 that stores a program, application, instruction, and/or data for the operation of the refrigerator 1. The processor 51 and the memory 52 may be implemented as separate semiconductor devices or may be implemented as a single semiconductor device.

In addition, the controller 50 may include a plurality of processors or a plurality of memories. The controller 50 may be provided at various locations inside the refrigerator 1. For example, the controller 50 may be configured as a printed circuit board that is arranged in a machine compartment (not shown) of the refrigerator 1.

The processor 51 may include an arithmetic circuit, a memory circuit, and a control circuit. The processor 51 may include one chip or may include a plurality of chips. In addition, the processor 51 may include one core or may include a plurality of cores.

The memory 52 stores various programs and data required for control, and may temporarily store temporary data generated during control. For example, the memory 52 may store a program for performing a water supply operation and an ice making cycle, and data required for performing a water supply operation and an ice making cycle.

The memory 52 may include a volatile memory, such as a static random access memory (S-RAM) and a dynamic random access memory (D-RAM), and a non-volatile memory, such as a read only memory (ROM) and an erasable programmable ROM (EPROM). The memory 52 may include one memory element or a plurality of memory elements.

The processor 51 may process data and/or signals using a program provided from the memory 52, and transmit a control signal to each component of the refrigerator 1 based on the processing result. Each component of the refrigerator 1 may be operated based on the control signal of the processor 51.

The refrigerator 1 may include a user interface 60. For example, the user interface 60 may be implemented as a control panel.

The user interface 60 may include an input device 61 provided to obtain user input. The input device 61 may be electrically connected to the controller 50. The input device 61 may transmit an electrical signal related to the obtained user input to the controller 50.

The types of user input that may be obtained through the input device 61 may include turning the power on/off, starting/stopping the ice making operation, setting the ice making operation, and the like.

The input device 61 may include various types of input devices such as a tact switch, a push switch, a slide switch, a toggle switch, a micro switch, or a touch switch.

The user interface 60 may include a display 62 for displaying information related to the operation of the refrigerator 1. The display 62 may provide various types of information based on image or other output signals received from the controller 50.

The operation information of the refrigerator 1 that may be displayed by the display 62 may include the status of the ice making operation, the status of the water supply operation, the amount of water supply, the progress of the ice making operation, the elapsed time or the time remaining until the end of the ice making operation, information on the occurrence of various errors, etc.

The display panel of the display 62 may include, for example, a liquid crystal display (LCD) panel, a light emitting diode (LED) panel, etc.

The refrigerator 1 may include a temperature sensor 491. For example, the temperature sensor 491 of the refrigerator 1 may be provided to detect the temperature of the ice trays 410 and 420. The temperature sensor 491 may output an electrical signal corresponding to the temperature of the ice trays 410 and 420. For example, the temperature sensor 491 may be mounted on the first tray case 411, but the location of the temperature sensor 491 is not limited thereto.

The temperature sensor 491 may be electrically connected to the controller 50. The temperature sensor 491 may output an electrical signal corresponding to the temperature of the ice trays 410 and 420 and transmit the electrical signal to the controller 50. The controller 50 may control the configuration of the power supply 600, the driver 470, the heater 480, etc. based on the electrical signal received from the temperature sensor 491.

As described above, the refrigerator 1 may include an ice full-detection lever 492 that detects the amount of ice stored in the ice bucket 100. For example, the ice full-detection lever 492 may output an electrical signal indicating whether the amount of ice stored in the ice bucket 100 is a predetermined amount or more. The “predetermined amount” described above may represent, for example, the maximum amount of ice that the ice bucket 100 may accommodate, and may be set experimentally and empirically. Information on the “predetermined amount” may be stored in the memory 52.

The ice full-detection lever 492 may be electrically connected to the controller 50. The ice full-detection lever 492 may output an electrical signal indicating whether the amount of ice stored in the ice bucket 100 is equal to or greater than the predetermined amount and transmit the signal to the controller 50. The controller 50 may control the configuration of the water supply valve 81, etc., based on the electrical signal received from the ice full-detection lever 492.

The refrigerator 1 may include a water supply valve 81 that opens or closes the water supply pipe 80.

The water supply valve 81 may be electrically connected to the controller 50. The controller 50 may control the water supply valve 81 based on a condition for opening or closing the water supply pipe 80. The water supply valve 81 may open or close the water supply pipe 80 based on a control signal received from the controller 50. For example, the controller 50 may control the water supply valve 81 to open the water supply pipe 80 based on a condition for supplying water into the ice making cells 412a and 422a to perform an ice making operation. For example, the controller 50 may receive a signal output from a flow sensor for detecting the amount of water supplied through the water supply pipe 80, a water level sensor for detecting the water level inside the ice making cells 412a and 422a, etc., and control the water supply valve 81 to close the water supply pipe 80 based on a condition for stopping the supply of water to the ice making cells 412a and 422a.

For example, the water supply valve 81 may be configured as a solenoid valve.

As described above, the refrigerator 1 may include a power supply 600 electrically connected to the plurality of terminals 500. The power supply 600 may be provided to apply a voltage to the frame terminal 500A or the water supply guide terminal 500B.

The power supply 600 may be electrically connected to the controller 50. The controller 50 may control the power supply 600 for the power supply 600 to apply or not apply a voltage to the frame terminal 500A or the water supply guide terminal. The power supply 600 may apply or not apply a voltage to the frame terminal 500A or the water supply guide terminal 500B based on a control signal received from the controller 50.

For example, the controller 50 may control the power supply 600 to apply a voltage to the frame terminal 500A based on a condition for heating at least a portion of the ice trays 412 and 422. Here, the condition for heating at least a portion of the ice trays 412 and 422 may include when the ice making operation is completed while the temperature of the ice trays 412 and 422 is below a predetermined ice making completion reference temperature or an ice making progress time exceeds a predetermined ice making completion reference time. Alternatively, the condition for heating at least a portion of the ice trays 412 and 422 may include when ice removal from the ice trays 412 and 422 is completed (removal of residual ice).

Alternatively, for example, the controller 50 may control the power supply 600 to apply a voltage to the water supply guide terminal 500B based on a condition for generating heat in the water supply guide 460. Here, the condition for generating heat in the water supply guide 460 may include when the supply of water to the ice trays 412 and 422 has ended, when the ice making operation has been completed, when the ice-moving operation has been completed, etc.

As described above, the refrigerator 1 may include a driver 470 for moving the second ice tray unit 420 and the first ejector 430 relative to the first ice tray unit 410. The driver 470 may move the second ice tray unit 420 such that the second ice tray unit 420 is separated from the first ice tray unit 410 in the ice-moving operation for discharging the ice after the ice formation in the ice trays 412 and 422 is completed, and may move the first ejector 430 such that the first ejector 430 press the first ice tray 412. When the ice moving operation is completed, the driver 470 may move the second ice tray unit 420 back to a position in which the second ice tray unit 420 is coupled to the first ice tray unit 410, and may move the first ejector 430 back to a position in which the first ejector 430 does not press the first ice tray 412.

The driver 470 may be electrically connected to the controller 50. More specifically, the motor of the driver 470 may be electrically connected to the controller 50. The controller 50 may control the motor of the driver 470 to separate the second ice tray unit 420 from the first ice tray unit 410 and allow the first ejector 430 to press the first ice tray 412 based on a condition for performing the ice moving operation. The motor of the driver 470 may be driven based on a control signal received from the controller 50.

As described above, the refrigerator 1 may include a heater 480. The heater 480 may be provided to locally heat a portion of the ice trays 412 and 422.

The heater 480 may be electrically connected to the controller 50. In order to improve the transparency of the ice, the controller 50 may turn the heater 480 on or off in real time based on conditions, such as the time for which ice making has been performed, the temperature of the ice trays 412 and 422, and the like during the ice making process in which ice is formed in the ice trays 412 and 422. The heater 480 may heat or not heat the ice trays 412 and 422 based on the control signal of the controller 50.

The configuration of the refrigerator 1 described above with reference to FIG. 11 is only an example of a refrigerator according to the concept of the disclosure, and the concept of the disclosure is not limited thereto.

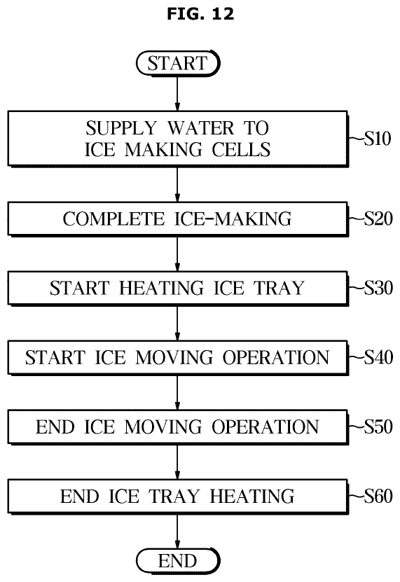

FIG. 12 is a flowchart showing a method of controlling a refrigerator according to an embodiment of the disclosure.

Referring to FIG. 12, the method of controlling a refrigerator 1 according to an embodiment of the disclosure may include an operation of supplying water to the ice making cells 412a and 422a in the ice trays 412 and 422 (S10). In this case, the controller 50 may control the water supply valve 81 to open the water supply pipe 80 based on a condition for starting an ice making operation.

For example, the condition for starting an ice making operation may include when a user input for forming ice is obtained. In addition, for example, the condition for starting an ice making operation may include when the amount of ice stored in the ice bucket 100 is less than a predetermined amount.

After water is supplied to the ice making cells 412a and 422a, the ice making operation may be completed when the temperature of the ice trays 412 and 422 is lower than a predetermined ice making completion reference temperature or a predetermined ice making completion reference time is exceeded, (S20). The controller 50 may determine to end the ice making operation based on the temperature of the ice trays 412 and 422 being lower than the predetermined ice making completion reference temperature or the predetermined ice making completion reference time being exceeded.

Thereafter, in order to facilitate the ice moving operation before discharging ice from the ice trays 412 and 422, an operation of heating the ice trays 412 and 422 may be performed (S30). Specifically, the controller 50 may control the power supply 600 to apply a voltage to the frame terminal 500A connected to the tray frame 413 to heat the tray frame 413 based on a condition for heating at least a portion of the ice trays 412 and 422.

After the heating the ice trays 412 and 422 starts, an ice moving in which ice is discharged from the ice trays 412 and 422 may start (S40). The controller 50 may control the motor of the driver 470 to move the second ice tray unit 420 and the first ejector 430 for the ice moving operation. The discharged ice may be moved to the ice bucket 100 and stored.

Thereafter, when the ice moving operation ends (S50), the controller 50 may control the motor of the driver 470 to move the second ice tray unit 420 back to a position in which the second ice tray unit 420 is coupled to the first ice tray unit 410 and to move the first ejector 430 to a position in which the first ejector 430 does not press the first ice tray 412.

Even after the ice moving operation is completed and the first ice tray unit 410 and the second ice tray unit 420 are coupled to each other, a voltage may be applied to the frame terminal 500A connected to the tray frame 413 to remove the remaining ice in the ice trays 412 and 422.

Thereafter, based on the temperature of the ice trays 412 and 422 being higher than a predetermined heating termination reference temperature or the heating time of the ice trays 412 and 422 being longer than a predetermined heating termination reference time, the controller 50 may control the power supply 600 not to apply a voltage to the frame terminal 500A. Accordingly, the heating of the ice trays 412 and 422 may be ended (S60).

Meanwhile, the controller 50 may, in order to generate heat in the water supply guide 460 before, during, or after the supply of water to the ice making cells 412a and 422a, control the power supply 600 to apply a voltage to the water supply guide terminal 500B connected to the water supply guide 460.

Alternatively, the controller 50 may, in order to generate heat in the water supply guide 460 together with the tray frame 413 when heating the tray frame 413 to heat the ice trays 412 and 422 before starting the ice moving operation, control the power supply 600 to apply a voltage to the water supply guide terminal 500B connected to the water supply guide 460.

Alternatively, the controller 50 may, in order to generate heat in the water supply guide 460 after the ice moving operation is ended, control the power supply 600 to apply a voltage to the water supply guide terminal 500B connected to the water supply guide 460.

The method of controlling the refrigerator 1 described above with reference to FIG. 12 is only an example, and the concept of the disclosure is not limited thereto.

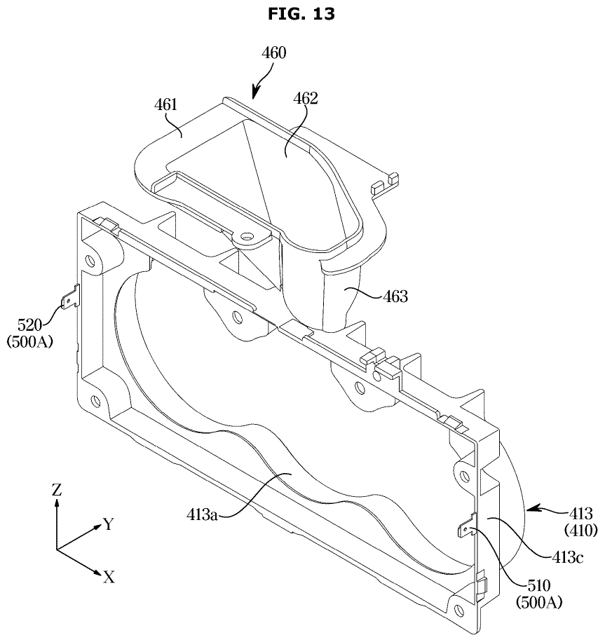

FIG. 13 is a view illustrating some components of an ice making unit of a refrigerator according to an embodiment of the disclosure.

In the description of an embodiment of the disclosure with reference to FIG. 13, the same components as those illustrated in FIGS. 1 to 12 may be given the same reference numerals and overlapping descriptions may be omitted.

Referring to FIG. 13, in the refrigerator 1 according to an embodiment of the disclosure, the tray frame 413 and the water supply guide 460 may be electrically connected to each other. That is, even when a terminal located in at least a part of the tray frame 413 and the water supply guide 460 is supplied with a voltage, current may flow through both the tray frame 413 and the water supply guide 460.

In detail, the tray frame 413 and the water supply guide 460 may be formed as one part. The tray frame 413 and the water supply guide 460 may be injection-molded with the same conductive material that generates heat when current flows therethrough. For example, the tray frame 413 and the water supply guide 460 may be injection-molded together using a material including carbon nanotubes.

As illustrated in FIG. 13, the tray frame 413 may be provided with frame terminals 500A. Specifically, a first terminal 510 and a second terminal 520 may be coupled to the frame body 413c. In contrast, the water supply guide 460 may not be provided with a terminal.

In this case, when a voltage is applied to the frame terminals 500A provided in the tray frame 413, current may flow to both the tray frame 413 and the water supply guide 460, and heat may be generated on both the tray frame 413 and the water supply guide 460.

The controller 50 may control the power supply 600 to apply a voltage to the first terminal 510 and the second terminal 520 based on a condition for heating at least a portion of the ice trays 412 and 422 or generating heat in the water supply guide 460.

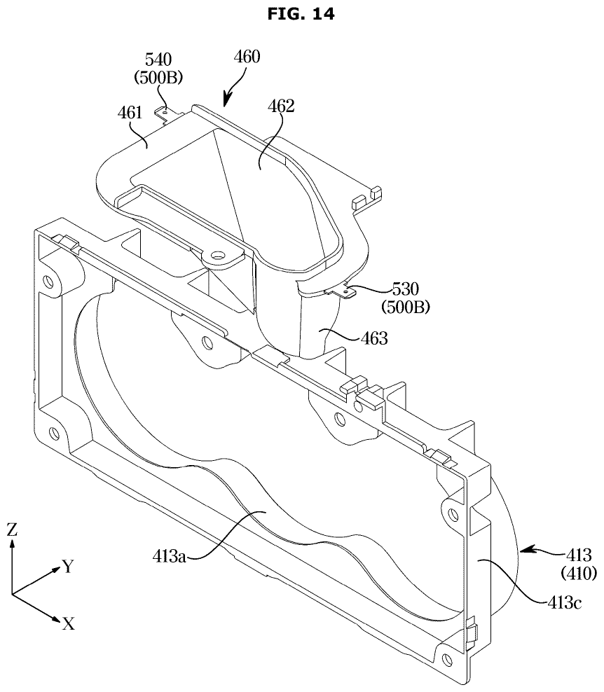

FIG. 14 is a view illustrating some components of an ice making unit of a refrigerator according to an embodiment of the disclosure.

In the description of an embodiment of the disclosure with reference to FIG. 14, the same components as those illustrated in FIGS. 1 to 12 may be given the same reference numerals and overlapping descriptions may be omitted.

Referring to FIG. 14, in the refrigerator 1 according to an embodiment of the disclosure, the tray frame 413 and the water supply guide 460 may be electrically connected to each other. That is, even when a voltage is applied between terminals 500 located in at least a part of the tray frame 413 and the water supply guide 460, current may flow through the tray frame 413 and the water supply guide 460.

Specifically, the tray frame 413 and the water supply guide 460 may be formed as one part. The tray frame 413 and the water supply guide 460 may be injection-molded using the same conductive material that generates heat when current flows therethrough. For example, the tray frame 413 and the water supply guide 460 may be injection-molded together using a material including carbon nanotubes.

As illustrated in FIG. 14, the water supply guide 460 may be provided with water supply guide terminals 500B. Specifically, a third terminal 530 and a fourth terminal 540 may be coupled to the guide body 461. In contrast, the tray frame 413 may not be provided with a terminal.

In this case, when a voltage is applied to the water supply guide terminals 500B provided in the water supply guide 460, current may flow through both the tray frame 413 and the water supply guide 460, and heat may be generated in both the tray frame 413 and the water supply guide 460.

The controller 50 may control the power supply 600 to apply a voltage between the third terminal 530 and the fourth terminal 540 based on a condition for heating at least a portion of the ice trays 412 and 422 or generating heat in the water supply guide 460.

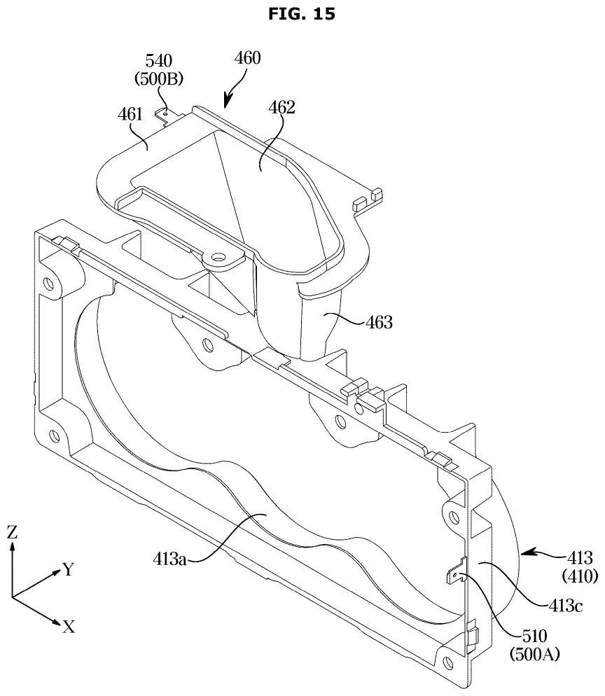

FIG. 15 is a view illustrating some components of an ice making unit of a refrigerator according to an embodiment of the disclosure.

In the description of an embodiment of the disclosure with reference to FIG. 15, the same components as those illustrated in FIGS. 1 to 12 may be given the same reference numerals and overlapping descriptions may be omitted.

Referring to FIG. 15, in the refrigerator 1 according to an embodiment of the disclosure, the tray frame 413 and the water supply guide 460 may be electrically connected to each other. That is, even when a voltage is applied between terminals 500 located in at least a part of the tray frame 413 and the water supply guide 460, current may flow through the tray frame 413 and the water supply guide 460.

In detail, the tray frame 413 and the water supply guide 460 may be formed as one part. The tray frame 413 and the water supply guide 460 may be injection-formed using the same conductive material that generates heat when current flows therethrough. For example, the tray frame 413 and the water supply guide 460 may be injection-formed together using a material including carbon nanotubes.

As illustrated in FIG. 15, one terminal 510 of the plurality of terminals may be provided in the tray frame 413, and the other terminal 540 of the plurality of terminals may be provided in the water supply guide 460. In detail, the frame body 413c has the first terminal 510 coupled thereto, and the guide body 461 has the fourth terminal 540 coupled thereto.

The controller 50 may control the power supply 600 to apply a voltage between the first terminal 510 and the fourth terminal 540 based on a condition for heating at least a portion of the ice trays 412 and 422 or generating heat in the water supply guide 460.

Unlike as shown in FIG. 15, the second terminal (520 in FIG. 8) may be provided in the tray frame 413, and the third terminal (530 in FIG. 8) may be provided in the water supply guide 460.

In this case, the controller 50 may control the power supply 600 to apply a voltage between the second terminal 520 and the third terminal 530 based on a condition for heating at least a portion of the ice trays 412 and 422 or generating heat in the water supply guide 460.

Alternatively, unlike as shown in FIG. 15, the first terminal 510 may be provided in the tray frame 413, and the third terminal (530 in FIG. 8) may be provided in the water supply guide 460.

In this case, the controller 50 may control the power supply 600 to apply a voltage between the first terminal 510 and the third terminal 530 based on a condition for heating at least a portion of the ice trays 412 and 422 or generating heat in the water supply guide 460.

Unlike as shown in FIG. 15, the second terminal (520 in FIG. 8) may be provided in the tray frame 413, and the fourth terminal 540 may be provided in the water supply guide 460.

In this case, the controller 50 may control the power supply 600 to apply a voltage between the second terminal 520 and the fourth terminal 540 based on a condition for heating at least a portion of the ice trays 412 and 422 or generating heat in the water supply guide 460.

In such embodiments, the distance between a pair of terminals may be arranged further than in the case of the embodiments of FIGS. 13 and 14, so that when a voltage is applied between the pair of terminals, uniform current may flow across approximately the entire area of the tray frame 413 and the water supply guide 460, and the uniformity of heat generation in the tray frame 413 and the water supply guide 460 may be improved.

With reference to FIGS. 1 to 15, embodiments in which the first tray frame 413 that supports the first ice tray 412 having a fixed position is configured to generate heat has been described, but the concept of the disclosure is not limited thereto. For example, the second tray frame 423 that supports the second ice tray 422 movably provided relative to the first ice tray 412 may include a material that generates heat when current flows therethrough, and terminals 500 may be connected to the second tray frame 423 such that when a voltage is applied to the terminals 500, the second tray frame 423 may generate heat.

With reference to FIGS. 1 to 15, the structure of an ice maker 200 mounted on the main body 10 and disposed in the storage compartment 20 has been described, but the concept of the disclosure may also be applied to the structure of an ice maker mounted on a door 30.

A refrigerator 1 according to an embodiment of the disclosure may include: an ice tray 412 configured to form ice; and a tray frame 413 supporting the ice tray, the tray frame including a material that generates heat upon current flowing therethrough and configured to transfer the generated heat to the ice tray. The tray frame may include a terminal 500A configured such that a voltage is applied to the tray frame.

The tray frame may contact an edge of the ice tray.

The tray frame may further include a frame body 413c configured to support the ice tray. At least a portion of the terminal may be inserted into the frame body.

The terminal may include: an insertion portion 501 inserted into the frame body; and a connecting portion 502 extending from the insertion portion to outside of the frame body.

The refrigerator may further include: a power supply 600 configured to apply a voltage to the terminal; and a terminal connector C2 electrically connected to the power supply by a wire. The terminal connector C2 is connected to the connecting portion 502 to electrically connect the power supply with the terminal. The tray frame may further include a frame body configured to support the ice tray. The terminal may include a pair of terminals coupled to the frame body. One terminal of the pair of terminals may be coupled to one side of the frame body in a longitudinal direction of the frame body. The other terminal of the pair of terminals may be coupled to another side of the frame body in the longitudinal direction.

The ice tray may include a plurality of ice-making cells in which water is stored and ice is formed. The plurality of ice-making cells may be arranged along the longitudinal direction of the frame body. The one terminal of the pair of terminals may be arranged adjacent to an ice-making cell of the plurality of ice-making cells that is located at one end of the frame body in the longitudinal direction. Another terminal of the pair of terminals may be arranged adjacent to an ice-making cell of the plurality of ice-making cells that is located at an opposite end of the frame body in the longitudinal direction.

The ice tray may be a first ice tray 412, and the refrigerator may further include a second ice tray 422 configured to be coupled to the first ice tray to form an ice-making cell together with the first ice tray in which water is stored and ice is formed, or configured to be separated from the first ice tray.

The tray frame 413 may be configured to heat an area in which the first ice tray 412 contacts the second ice tray 422 while the first ice tray 412 and the second ice tray 422 are coupled to each other.

The first ice tray may include a contact portion 412e configured to contact the second ice tray while being coupled to the second ice tray, the contact portion being formed along an edge of the ice-making cell. The tray frame may cover an outer periphery of the contact portion.

The first ice tray may be fixed to the tray frame. The second ice tray may be configured to be movable between a position in which the second ice tray is coupled to the first ice tray and a position in which the second ice tray is separated from the first ice tray.

The material, included in the tray frame, being configured to generate heat upon current flowing therethrough may include a carbon nanotube (CNT) material.

The refrigerator may further include a water supply pipe 80 configured to supply the ice tray with water; and a water supply guide 460 configured to guide water from the water supply pipe to the ice tray and including a material that generates heat upon current flowing therethrough.

The refrigerator may further include a water supply guide terminal 500B coupled to the water supply guide and configured such that a voltage is applied to the water supply guide.

The tray frame 413 and the water supply guide 460 may be formed integrally.

A refrigerator 1 according to an embodiment of the disclosure may include: ice trays 412 and 422 configured to form ice; a water supply pipe 80 configured to supply the ice trays with water; and a water supply guide 460 configured to guide water from the water supply pipe to the ice tray and including a material that generates heat upon current flowing therethrough. The water supply guide may include a terminal 500B configured to apply a voltage to the water supply guide.

The terminal may include a pair of terminals. One terminal of the pair of terminals may be provided on one side of a periphery of the water supply guide. The other terminal of the pair of terminals may be provided on another side of the periphery of the water supply guide.

The water supply guide may further include a guide body 461. At least a portion of the terminal may be inserted into the guide body.

The refrigerator may further include an ice tray configured to generate ice, and a tray frame, supporting the ice tray and formed of a material that generates heat upon current flowing therethrough, configured to transfer the generated heat to the ice tray. The tray frame and the water supply guide may be formed integrally.

A refrigerator 1 according to an embodiment of the disclosure may include: an ice tray 412 configured to form ice; a tray frame 413 contacting the ice tray and configured to generate heat upon current flowing therethrough; a power supply 600 configured to apply a voltage to a terminal electrically connected to the tray frame; and a controller 50 electrically connected to the power supply. The controller may be configured to control the power supply to apply a voltage to the terminal based on a condition for heating at least a portion of the ice tray.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be a Read Only Memory (ROM), a Random Access Memory (RAM), a magnetic tape, a magnetic disk, a flash memory, and an optical data storage device.

Storage medium readable by machine may be provided in the form of a non-transitory storage medium. “Non-transitory” means that the storage medium is a tangible device and does not contain a signal (e.g., electromagnetic wave), and this term includes a case in which data is semi-permanently stored in a storage medium and a case in which data is temporarily stored in a storage medium. For example, a “non-transitory storage medium” may include a buffer in which data is temporarily stored.

The method according to the various disclosed embodiments may be provided by being included in a computer program product. Computer program products may be traded between sellers and buyers as commodities. Computer program products are distributed in the form of a device-readable storage medium (e.g., compact disc read only memory (CD-ROM)), or are distributed directly or online (e.g., downloaded or uploaded) between two user devices (e.g., smartphones) through an application store (e.g., Play Store™). In the case of online distribution, at least a portion of the computer program product (e.g., downloadable app) may be temporarily stored or created temporarily in a device-readable storage medium such as the manufacturer's server, the application store's server, or the relay server's memory.

According to one aspect of the disclosure, a refrigerator may include a tray frame including a material that generates heat upon current flowing therethrough, and thus when ice-making is completed, the produced ice can be effectively discharged by heating ice trays using the tray frame.

According to one aspect of the disclosure, a refrigerator may include a tray frame including a material that generates heat upon current flowing therethrough, and thus after ice is discharged from ice trays, remaining ice in the ice trays can be effectively removed.

According to one aspect of the disclosure, a refrigerator may include a tray frame that generates heat upon current flowing therethrough, and thus ice trays can be heated without having a separate heater.

According to one aspect of the disclosure, a refrigerator may include a water supply guide that generates heat upon current flowing therethrough, and thus freezing of water in the water supply guide can be prevented without having a separate heater.

According to one aspect of the disclosure, a refrigerator may include a tray frame that generates heat across approximately the entire area upon a voltage applied thereto, and thus heat generation efficiency and heat transfer efficiency can be improved.

According to one aspect of the disclosure, a refrigerator may include a water supply guide that generates heat across approximately the entire area upon a voltage applied thereto, and thus heat generation efficiency and heat transfer efficiency can be improved.

The effects of the disclosure are not limited to the effects described above, and other effects that are not described will be clearly understood by those skilled in the art from the above detailed description.

While the disclosure has been particularly described with reference to exemplary embodiments, it should be understood by those of skilled in the art that various changes in form and details may be made without departing from the spirit and scope of the disclosure.

1. A refrigerator comprising:
an ice tray configured to form ice; and
a tray frame including a frame body to support the ice tray and a terminal connected to the frame body,
wherein the frame body includes a heat-generating material, and the tray frame is configured so that, with the ice tray supported by the frame body, a voltage is appliable to the terminal to generate a current flow through the heat-generating material so that the heat-generating material generates heat that is transferred by the frame body to the ice tray to heat the ice tray.

2. The refrigerator of claim 1, wherein, with the ice tray supported by the frame body, the frame body contacts an edge of the ice tray.

3. The refrigerator of claim 1, wherein
at least a portion of the terminal is inserted into the frame body.

4. The refrigerator of claim 3, wherein
the terminal includes:
an insertion portion inserted into the frame body, and
a connecting portion extending from the insertion portion to outside of the frame body.

5. The refrigerator of claim 4, further comprising:
a power supply configured to apply the voltage to the terminal; and
a terminal connector electrically connected to the power supply by a wire,
wherein the terminal connector is connected to the connecting portion to electrically connect the power supply with the terminal.

6. The refrigerator of claim 1, wherein
the terminal includes a pair of terminals coupled to the frame body, and
a first terminal of the pair of terminals is coupled to a first side of the frame body in a longitudinal direction of the frame body, and a second terminal of the pair of terminals is coupled to a second side of the frame body in the longitudinal direction.

7. The refrigerator of claim 6, wherein
the ice tray includes a plurality of ice-making cells in which water is storable and ice is formable,
the plurality of ice-making cells are arranged along the longitudinal direction of the frame body, and
the first terminal of the pair of terminals is arranged adjacent to an ice-making cell of the plurality of ice-making cells that is located at a first end of the frame body in the longitudinal direction, and the second terminal of the pair of terminals is arranged adjacent to an ice-making cell of the plurality of ice-making cells that is located at a second end of the frame body in the longitudinal direction that is opposite to the first end.

8. The refrigerator of claim 1, wherein
the ice tray is a first ice tray, and
the refrigerator further includes a second ice tray configured to be couplable to, and separatable from, the first ice tray so that, with the second ice tray coupled to the first ice tray, the first ice tray and the second ice tray together form an ice-making cell in which water is storable and ice is formable.

9. The refrigerator of claim 8, wherein the tray frame is configured so that, with the voltage applied to the terminal so as to generate the current flow through the heat-generating material so that the heat-generating material generates heat, the tray frame transfers at least a portion of the generated heat to an area in which the first ice tray contacts the second ice tray when the second ice tray is coupled to the first ice tray.

10. The refrigerator of claim 9, wherein
the first ice tray includes a contact portion along an edge of the ice-making cell, the contact portion configured to, with the second ice tray coupled to the first ice tray, contact the second ice tray, and
the frame body covers an outer periphery of the contact portion.

11. The refrigerator of claim 8, wherein
the first ice tray is fixed to the frame body, and
the second ice tray is configured to be movable between a coupled position in which the second ice tray is coupled to the first ice tray and a separated position in which the second ice tray is separated from the first ice tray.

12. The refrigerator of claim 1, wherein the heat-generating material includes a carbon nanotube (CNT) material.

13. The refrigerator of claim 1, wherein
the heat-generating material is a first heat-generating material,
wherein the refrigerator further comprises:
a water supply pipe configured to supply water; and
a water supply guide configured to guide the water supplied by the water supply pipe to the ice tray, the water supply guide including a second heat-generating material that generates heat upon current flowing through the second heat-generating material.

14. The refrigerator of claim 13, further comprising a water supply guide terminal coupled to the water supply guide and configured so that a voltage is appliable to the water supply guide terminal to generate the current flow through the another material.

15. The refrigerator of claim 13, wherein the frame body and the water supply guide are integral.

16. A refrigerator comprising:
an ice tray configured to form ice;
a water supply pipe configured to supply water; and
a water supply guide including a guide body configured to guide the water supplied by the water supply pipe to the ice tray and a terminal connected to the guide body
wherein the guide body includes a heat-generating material, and the water supply guide is configured so that, a voltage is appliable to the terminal to generate a current flow through the heat-generating material so that the heat-generating material generates heat.

17. A refrigerator comprising:
an ice tray configured to form ice;
a tray frame contacting the ice tray and configured to generate heat upon current flowing through the tray frame;
a power supply configured to apply a voltage to a terminal electrically connected to the tray frame; and
a controller electrically connected to the power supply,
wherein the controller is configured to control the power supply to apply the voltage to the terminal based on a condition for heating at least a portion of the ice tray.
